(19) United States
(12) Patent Application Publication
(10) Pub. No.: US 2010/0100266 A1
(43) Pub. Date: Apr. 22, 2010

(54) Thermal management system for vehicle

(75) Inventors: Takeshi Yoshinori, Okazaki-city (JP); Yasumitsu Oomi, Okazaki-city (JP); Hitoshi Ninomiya, Kariya-city (JP); Masamichi Makihara, Anjo-city (JP); Kouji Mori, Nagoya-city (JP); Yoshimitsu Inoue, Chirya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/589,108

(22) Filed: Oct. 16, 2009

(30) Foreign Application Priority Data
Oct. 17, 2008 (JP) 2008-268995
Jan. 23, 2009 (JP) 2009-013459

(51) Int. Cl. B60W 20/00

(52) U.S. Cl. 701/22; 701/36; 903/904

(57) ABSTRACT

A thermal management system for a vehicle includes a switching power supply device, an electronic member configured to output an electrical power adjusted by the switching power supply device, and a control device configured to control operation of the switching power supply device. When the control device receives a heating request from at least one of devices that include a drive device used for driving the vehicle and an air conditioning device used for performing an air conditioning in a vehicle compartment, the control device causes the switching power supply device to be operated in a heat increasing operation in which heat generated from the electronic member is increased more than that in a general operation state, and supplies the generated heat to the at least one of the drive device and the air conditioning device.

### CROSS REFERENCE TO RELATED APPLICATION

This application is based on Japanese Patent Applications No. 2008-268995 filed on Oct. 17, 2008, and No. 2009-013459 filed on Jan. 23, 2009, the contents of which are incorporated herein by reference in its entirety.

### FIELD OF THE INVENTION

The present invention relates to a thermal management system, which can effectively use heat generated in a vehicle, for a heating.

### BACKGROUND OF THE INVENTION

A heating system for a vehicle is known in JP 2004-265771A or JP 7-94202A, for example. In the heating system described in JP 2004-265771A or JP 7-94202A, a heating of a fuel cell for a vehicle is performed so as to improve power generating efficiency at a start time of the fuel cell.

The heating system of JP 2004-265771A is provided with a circulation circuit through which coolant flows inside of the fuel cell. When the temperature of the fuel cell is lower than 20° C., the fuel cell is intermittently operated to generate electrical power, and an electrical heater is operated by the generated electrical power to heat the coolant, thereby increasing the temperature of the fuel cell.

In the heating system described in JP 7-94202A, a coolant circuit in which coolant circulates is provided for heating or cooling the fuel cell, and a heater located in a water storage tank of the coolant circuit is turned on so as to facilitate the heating of the fuel cell.

In a fuel cell vehicle or an electrical vehicle, a special electrical heater is adapted as described above, in order to secure a heat source for heating a vehicle compartment. Therefore, a mounting space for the special electrical heater is necessary in the fuel cell vehicle or the electrical vehicle, and the cost is also increased due to the special electrical heater. Further, in a hybrid vehicle, an engine is operated in order to secure the heating of the vehicle compartment.

Thus, in the conventional heating system, the fuel consumption is deteriorated thereby increasing the cost. In particular, because the performance of a battery for the running of the vehicle is decreased at a low temperature, it is difficult to perform a necessary output and to regenerate electrical power, thereby deteriorating the fuel consumption. Furthermore, the thermal heat for the heating is only supplied from the special electrical heater, and thereby the cost of the heating system is increased.

### SUMMARY OF THE INVENTION

In view of the foregoing problems, it is an object of the present invention to provide a thermal management system for a vehicle, which can perform a heating of a device without using a special heating machine only for the heating of the device.

It is another object of the present invention to provide a thermal management system for a vehicle, which can perform a heating of a device mounted to the vehicle, at a low cost.

According to an aspect of the present invention, a thermal management system for a vehicle includes a switching power supply device, an electronic member configured to output an electrical power adjusted by the switching power supply device, and a control device configured to control operation of the switching power supply device so as to control operation of the electronic member. In the thermal management system, when the control device receives a heating request from at least one of devices that include a drive device used for driving the vehicle and an air conditioning device used for performing an air conditioning in a vehicle compartment, the control device causes the switching power supply device to be operated in a heat increasing operation in which heat generated from the electronic member is increased more than that in a general operation state, and supplies the generated heat to the at least one of the drive device and the air conditioning device.

That is, the heat increasing operation is an inefficient control operation in which the electronic member is operated inefficiently to generate heat. Accordingly, in the heat increasing operation, heat can be purposefully generated from the electronic member used for the vehicle, and is supplied to the device having the heating request. Therefore, the device having the heating request can be effectively heated at a low cost, without using a special heating machine.

For example, the control device may increase the number of transient states in which electrical current and electrical voltage applied to the switching power supply device vary or the time for each transient state during the heat increasing operation, to be larger than that in the general operation state.

Alternatively, the control device may input a control signal in which at least one of a drive frequency and a duty ratio is increased as compared with the general operation state, to the switching power supply device, during the heat increasing operation. Alternatively, the control device may increase at east one of electrical current and electrical voltage applied to the switching power supply device as compared with the general operation state, during the heat increasing operation.

As an example, the electronic member may be at least one of an inverter, a voltage increasing converter, a DC/DC converter or the like. The devices with the heating request may be a cell stack, an engine, a motor, a heater core, a component of a refrigerant cycle or the like.

For example, when the control device receives a heating request from a cell stack that is the device having the heating request and is configured to supply electrical power to a motor for a vehicle traveling, the control device causes the switching power supply device to be operated in the heat increasing operation, and supplies the generated heat to the cell stack. When the control device receives a heating request from an engine for a vehicle traveling, which is the device having the heating request, the control device causes the switching power supply device to be operated in the heat increasing operation, and supplies the generated heat to the engine. When the control device receives a heating request from a motor for a vehicle traveling, which is the device having the heating request, the control device causes the switching power supply device to be operated in the heat increasing operation, and supplies the generated heat to the motor. When the control device receives a heating request from a component of a refrigerant cycle used for the air conditioning of the vehicle compartment, the control device causes the switching power supply device to be operated in the heat increasing operation, and supplies the generated heat to the component of the refrigerant cycle. Furthermore, when the control device receives a heating request for a heater core for heating air to be blown into the vehicle compartment, the control device causes the switching power supply device to be operated in the heat increasing operation, and supplies the generated heat to the heater core.

The thermal management system may be provided with a fluid circuit in which a fluid circulates. In this case, both the device having the heating request and the electronic member may be located in the fluid circuit to perform heat exchange with the fluid, and the fluid circuit may be configured to supply the heat generated in the heat increasing operation to the device having the heating request via the fluid as a thermal medium.

Alternatively, the thermal management system may be provided with a first fluid circuit in which a fluid circulates, and a second fluid circuit connected to the first fluid circuit to be separated from the first fluid circuit. In this case, the device having the heating request may be located in the first fluid circuit to perform heat exchange with the fluid in the first fluid circuit, and the electronic member may be located in the second fluid circuit to perform heat exchange with the fluid in the second fluid circuit. Furthermore, the control device may control the first and second fluid circuits to be connected in the heat increasing operation, so as to supply the heat generated in the heat increasing operation, to the device having the heating request via the fluid as a thermal medium.

When the control device receives a heating request from a cell stack of the vehicle, which is the device having the heating request, the control device connects a fluid passage through which a heater core for heating air to be blown into the vehicle compartment is connected to the electronic member, and supplies the heat generated in the heat increasing operation to the cell stack by using air heated by the heater core as a thermal transmission medium.

According to another aspect of the present invention, a thermal management system includes a cell stack in which a plurality of cell modules are electrically connected and are stacked to be integrated, a switching power supply device, an electronic member configured to output an electrical power adjusted by the switching power supply device and adapted to charge and discharge the cell modules or to adjust a temperature of the cell modules, and a control device configured to control operation of the switching power supply device and to perform a heating of the cell stack when a predetermined condition is satisfied. In the thermal management system, when the control device detects that a temperature of the cell modules is lower than a predetermined temperature, the control device causes the switching power supply device to be operated in an inefficient control operation in which the number of transient states where electrical current and electrical voltage applied to the switching power supply device vary or the time for each transient state is larger than that in a general operation state. Accordingly, in the inefficient control operation, heat is purposefully generated from the electronic member adapted for the vehicle, and heat radiated from the electronic member can be facilitated, thereby effectively performing the heating of the cell stack without adding a special heating machine. Thus, the heating of the cell stack can be performed at a low cost.

For example, the switching power supply device is a power element. In this case, the control device may increase at least one of a drive frequency and a duty ratio inputted to the power element, so as to perform the inefficient control operation. Furthermore, the control device may change an increase amount of at least one of the drive frequency and the duty ratio inputted to the power element, based on the temperature of the cell modules when the temperature of the cell modules is lower than the predetermined temperature.

As an example, the control device may determine that the temperature of the cell modules is lower than the predetermined temperature, by using at least one of (a) cell information that includes a temperature, a voltage, a current and an inner resistance of the cell modules, (b) environmental information of the cell modules including an environmental temperature, and (c) system information that includes a temperature or an operation state of the switching power supply device or the electronic device.

Alternatively, the electronic member may include a DC/DC converter connected between a high-voltage electrical power system including the cell stack and a low-voltage electrical power system including a low-voltage battery. In this case, the high-voltage electrical power system may be connected to a high-voltage load to be capable of supplying and receiving electrical power, and the low-voltage battery may be connected to a low-voltage load to supply electrical power to the low-voltage load.

As an example, the cell stack may be approximately a rectangular parallelepiped shape, and the thermal management system may further include a blower member located adjacent to one surface of the cell stack. The blower member may include a centrifugal fan accommodated in a casing. In the blower member, the casing may be provided with a suction port opened in a direction parallel to a longitudinal direction of the one surface of the cell stack, and an air passage expanding in a width direction as toward an air outlet that is opened toward the cell stack. Furthermore, the electronic member may be located at a side of the casing, inside longitudinal ends of the one surface of the cell stack. In this case, the electronic member can be located in compact, without increasing the outer dimension of the cell stack.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic diagram showing a thermal management system according to a first embodiment of the present invention;

FIG. 2 is a block diagram showing a control device of the thermal management system according to the first embodiment;

FIG. 3A is a schematic diagram showing a control signal inputted to a power element (i.e., switching power supply device) in a general operation state, and FIG. 3B is a graph showing electrical current I and electrical voltage V applied to the power element, in the generation operation state, according to the first embodiment;

FIG. 4A is a schematic diagram showing an example of a control signal inputted to a power element (i.e., switching power supply device) in a heat increasing operation (inefficient control operation), and FIG. 4B is a graph showing electrical current I and electrical voltage V applied to the power element in the example of FIG. 4A, according to the first embodiment;

FIG. 5 is a schematic diagram showing another example of a control signal inputted to the power element in the heat increasing operation, according to the first embodiment;

FIG. 6 is a schematic diagram showing another example of a control signal inputted to the power element in the heat increasing operation, according to the first embodiment;

FIG. 7 is a flow diagram showing a control operation in a heating request state of the thermal management system according to the first embodiment;

FIG. 8 is a schematic diagram showing a thermal management system according to a second embodiment of the present invention;

FIG. 9 is a schematic diagram showing a thermal management system according to a third embodiment of the present invention;

FIG. 10 is a schematic diagram showing a thermal management system according to a fourth embodiment of the present invention;

FIG. 11 is a schematic diagram showing a thermal management system according to a fifth embodiment of the present invention;

FIG. 12 is a schematic diagram showing a thermal management system according to a sixth embodiment of the present invention;

FIG. 13 is a schematic diagram showing a thermal management system according to a seventh embodiment of the present invention;

FIG. 14 is a block diagram showing a thermal management system with a cell heating device according to an eighth embodiment of the present invention;

FIG. 15 is a schematic diagram showing an integrated structure of a cell stack, blower members and electronic members, according to the eighth embodiment;

FIG. 16 is a schematic diagram showing a thermal transmission state in a heating of the cell heating device, according to the eighth embodiment;

FIG. 17 is a flow diagram showing a cell temperature control in the cell heating device, according to the eighth embodiment;

FIG. 18 is a graph showing a relationship between a drive frequency inputted to the power element (switching power supply device) and a cell temperature Td, in the cell heating, according to the eighth embodiment; and

FIG. 19 a graph showing a relationship between a drive duty ratio inputted to the power element (switching power supply device) and the cell temperature Td, in the cell heating, according to the eighth embodiment.

### DETAILED DESCRIPTION OF THE PREFERRED EMBODIMENTS

### Embodiments

Embodiments for carrying out the present invention will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

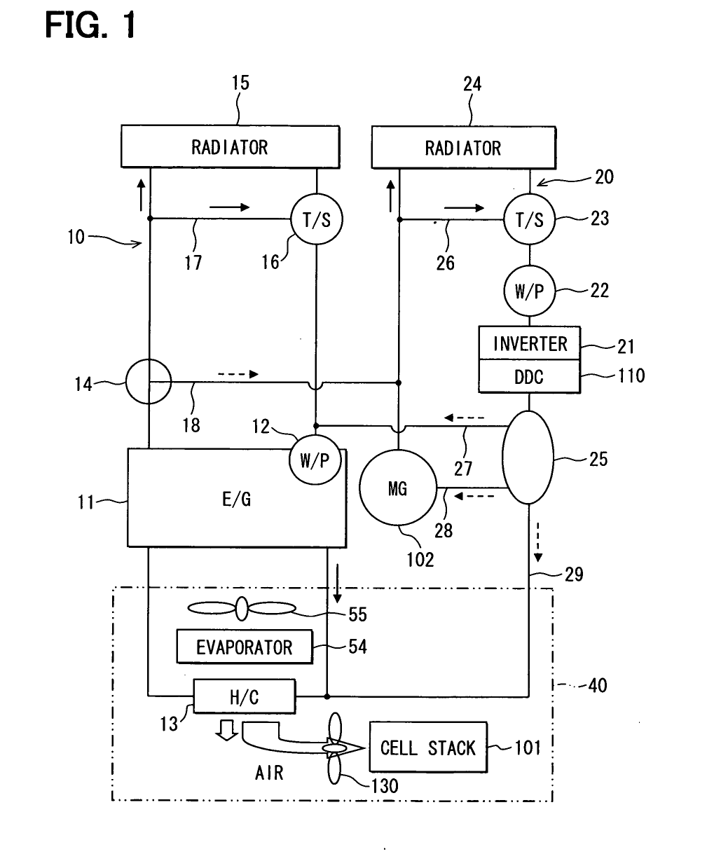

A thermal management system according to a first embodiment of the present invention will be described with reference to FIGS. 1 to 7. The thermal management system of the present embodiment can be suitably used for a hybrid vehicle which is traveling by a driving source using the combination of an internal combustion engine and a motor driven by electrical power charged in a battery, an electrical vehicle which is traveling by a driving source using a motor driven by electrical power charged in a battery, a fuel cell vehicle using a hybrid system of a fuel cell and a secondary battery, or the like. The thermal management system increases heat generated in an electronic device in a heating request state in which a predetermined condition satisfies, transmits the heat via a fluid, and supplies the heat to a device that requests a heating. For example, the thermal management system increases heat generated in an electronic device at the heating request state, by reducing efficiency as compared with a general operation state. In the thermal management system, a switching power supply device is controlled to increase the generated heat at the heating request state as compared with the general operation state.

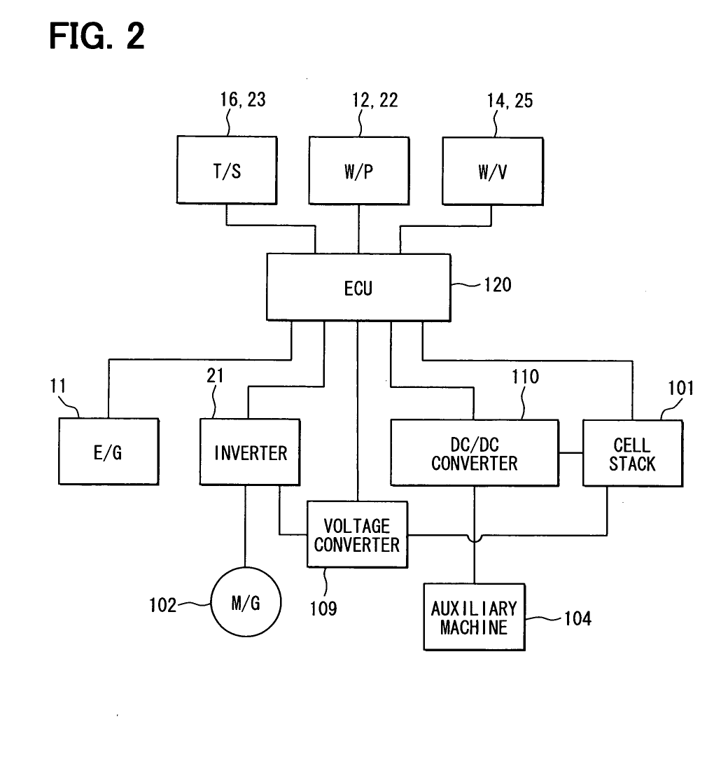

FIG. 1 is a schematic diagram showing the thermal management system of the first embodiment, and FIG. 2 is a block diagram showing a control device of the thermal management system of the first embodiment.

As shown in FIG. 1, the thermal management system for a vehicle includes a first coolant circuit 10 provided with a coolant passage of an internal combustion engine 11, a second coolant circuit 20 provided a coolant circuit of an inverter 21 and a DC/DC converter 110 and the like, and a control device 120 that controls operation of various components in the first and second coolant circuits 10, 20 so as to transfer heat generated in the vehicle to a device having a heating request.

The first coolant circuit 10 is an example of a cooling system mounted to the vehicle driven by the engine 11, and is configured such that coolant (e.g., coolant including ethylene glycol) for cooling the engine 11 circulates in the first coolant circuit 10. The first coolant circuit 10 includes a radiator 15, and a heater core 13 coupled to the engine 11. The radiator 15 has therein a coolant passage in which the coolant flows, and an air passage in which air flows. Therefore, the coolant passing through the coolant passage of the radiator 15 is heat exchanged with air, and is cooled.

The engine 11 is a water-cooled internal combustion engine cooled by the coolant sent by a pump 12 to a water jacket within the engine 11. The first coolant circuit 10 is a circuit in which high-temperature coolant having passed through the water jacket of the engine 11 flows. The radiator 15 and the engine 11 are coupled by a coolant passage of the first coolant circuit 10. Thus, the first coolant circuit 10 has a radiator-side coolant passage connecting the radiator 15 and the water jacket of the engine 11, and a heater-side coolant passage connecting the heater core 13 and the engine 11. The radiator 15 is a heat exchanger that cools high-temperature coolant flowing from the water jacket of the engine 11 by the operation of the pump 12.

The radiator-side coolant passage is connected with a bypass passage 17 through which the coolant flowing out of the engine 11 returns to the engine 11 after bypassing the radiator 15. A thermostat 16 is provided at a connection portion between the bypass passage 17 and the radiator-side coolant passage. The thermostat 16 is configured to adjust a ratio between a flow amount of the coolant flowing through the radiator 15 and a flow amount of the coolant flowing through the bypass passage 17 to be in a range of 0% to 100%. For example, when a heating of the engine 11 is performed, the flow amount of coolant flowing through the bypass passage 17 is increased so as to reduce the heat radiation of coolant in the radiator 15, thereby facilitating the heating. In this case, it can prevent the coolant from being super-cooled by the radiator 15.

A radial inner dimension of a pipe for defining the radiator-side coolant passage can be set larger than a radial inner dimension of a pipe defining the bypass passage 17, so that a larger amount of the coolant can generally flow into the radiator 15. The thermostat 16 may be configured by a flow amount adjusting valve or a switching valve, or the like.

A bypass passage 18 is branched from the radiator-side coolant passage and is connected to the second coolant circuit 20, such that the coolant flowing out of the engine 11 flows into the second coolant circuit 20 without flowing into the radiator 15. A passage adjusting device 14 is located at a connection portion of the bypass passage 18 and the radiator-side coolant passage, to adjust a passage open area. The passage adjusting device 14 is configured to adjust a ratio between a flow amount of the coolant flowing through the radiator 15 and a flow amount of the coolant flowing to the second coolant circuit 20 through the bypass passage 18, to be in a range of 0% to 100%. Therefore, the passage adjusting device 14 can switch the flow of coolant to the side of the radiator 15 or to the side of the second coolant circuit 20. The passage adjusting device 14 may be configured by a flow amount adjusting valve or a switching valve, or the like.

A heater-side coolant passage is coupled to the radiator-side coolant passage in the first coolant circuit 10, and the coolant is circulated in the heater-side coolant passage by the pump 12. The heater core 13 is provided with an air passage, and a coolant passage through which the coolant of the first coolant circuit 10 flows to perform heat exchange with air in the air passage. The heater core 13 is located in an air conditioning case of an air conditioning unit of a vehicle air conditioner, and is located in a vehicle compartment 40 partitioned from an engine compartment of the vehicle. The heater core 13 is located in the air conditioning case downstream of an evaporator 54 in an air flow, to heat air blown by a blower 55 and having passed through the evaporator 54 at a desired temperature.

The inverter 21, the DC/DC converter 110 and a driving motor 102 are arranged in the second coolant circuit 20. The second coolant circuit 20 is configured to have a coolant passage through which coolant passes through the inverter 21 and the DC/DC converter 110 to perform transfer of heat generated in the DC/DC converter 110 and the converter 21 to the coolant, and a coolant passage through the coolant passes through the motor 102 to perform transfer of heat generated in the motor 102 to the coolant. The second coolant circuit 20 is a circuit through which the coolant (e.g., coolant including ethylene glycol) for adjusting the temperature of the inverter 21 or/and the motor 102 flows. The second coolant circuit 20 has a coolant passage 28 through which the coolant flowing out of the inverter 21 flows into the motor 102. A radiator 24 is located in the second coolant circuit 20, and has a coolant passage and an air passage, thereby performing heat exchange between air passing through the air passage and the coolant passing through the coolant passage in the radiator 24.

The radiator 24 is a heat exchanger configured to perform heat exchange between the coolant flowing from the inverter 21 or/and the motor 102 by a pump 22, and air. Therefore, the coolant can be cooled in the radiator 24. A bypass passage 26 is connected to the coolant passage between the radiator 24 and the motor 102, such that the coolant flowing out of the motor 102 flows into the inverter 21 through the bypass passage 26 while bypassing the radiator 24. A thermostat 23 is located in the second coolant circuit 20 to adjust a ratio between a flow amount of the coolant flowing through the radiator 24 and a flow amount of the coolant flowing through the bypass passage 26 to be in a range of 0% to 100%. For example, when a heating of a device having a heating request is performed, the flow amount of coolant flowing through the bypass passage 26 is increased so as to reduce the heat radiation of coolant in the radiator 24, thereby facilitating the heating. In this case, it can prevent the cooling water from being super-cooled by the radiator 24. The thermostat 23 may be configured by a flow amount adjusting valve or a switching valve, or the like.

A bypass passage 27 and a bypass passage 29 are respectively provided to be branched from the second coolant circuit 20. The bypass passage 27 is branched from the second coolant circuit 20 and is connected to the first coolant circuit 10 such that the coolant flowing from the inverter 21 flows to the engine 11 of the first coolant circuit 10 without flowing into the motor 102. The bypass passage 29 is branched from the second coolant circuit 20 and is connected to the first coolant circuit 10 such that the coolant flowing from the inverter 21 flows to the heater core 13 of the first coolant circuit 10 without flowing into the motor 102. A passage adjusting device 25 is located in the second coolant circuit 20 to adjust a passage open area. The passage adjusting device 25 is configured to adjust a ratio among a flow amount of the coolant flowing through the motor 102, a flow amount of coolant flowing through the heater core 13 and a flow amount of the coolant flowing to the engine 11, to be in a range of 0% to 100%. Therefore, the passage adjusting device 25 can switch the flow of coolant to at least one among the side of the motor 102, the side of the heater core 13 and the side of the engine 11. The passage adjusting device 25 may be configured by a flow amount adjusting valve or a switching valve, or the like.

A cell stack 101 (high-voltage battery) is located to supply electrical power to the motor 102 that is a drive source for a vehicle running. For example, the cell stack 101 is located in the vehicle compartment 40 in which the air conditioning unit including the heater core 13 is provided. The cell stack 101 may be a nickel-hydrogen secondary battery, a lithium-ion secondary battery, an organic radical battery or the like. The cell stack 101 is configured by stacking a plurality of cell modules. The cell modules of the cell stack 101 are capable of charging and discharging, or/and its temperature adjusting, by using an electronic member.

The cell stack 101 is mounted to the vehicle as a battery package or a combination package combined with a blower member 130. The blower member 130 can forcibly blow air to the cell stack 101. The cell stack 101 can be accommodated in a casing, and can be located under a seat of the vehicle, a space between the rear seat and a trunk room or a space between the driver's seat and the front-passenger's seat in the vehicle compartment 40. The blower member 130 can be configured to send the air having heated by the heater core 13 to the cell stack 101. In this case, warm air absorbing heat from the coolant is supplied by the blower member 130 to the cell stack 101, thereby heating the cell stack 101.

The control operation of the thermal management system will be described with reference to FIG. 2. A control device (ECU) 120 is an electronic control unit that controls operation of the components off the first coolant circuit 10, the second coolant circuit 20 and the like so as to control thermal transmission at the heating request state. The control device 120 may be adapted as an electric control unit for controlling air-conditioning of the vehicle compartment, or/and an electric control unit for controlling the engine temperature.

The control device 120 includes a microcomputer, an input circuit, and an output circuit. Input signals such as a start signal of the engine 11, signals from various sensors and signals from various switches and the like are input to the input circuit of the control device 120. Output signals are outputted from the output circuit to various actuators, a power control unit (PCU) and the like. The actuators include the pumps 12, 22, the passage adjusting devices 14, 25 and the thermostats 16, 23, for example. The power control unit (PCU) includes the inverter 21, a voltage increasing converter 109, the DC/DC converter 110 and the like. The microcomputer is configured by a ROM, a memory such as RAM, a CPU and the like which are generally known. The microcomputer performs various calculations by using programs stored in the RAM. Thus, the control device 120 can controls operations of the various actuators, the inverter 21, the voltage increasing converter 109, the DC/DC converter 110, the cell stack 101, the blower member 130 and the like, based on a result calculated by using the various programs. The control device 120 starts its operation when an ignition switch is turned on and electrical power is supplied thereto from an auxiliary battery. The control device 120 is configured to perform communication with various control devices such as a vehicle ECU, via communication lines connected to a communication connector.

The electronic members, which generate heat in the heat-increasing operation at the heat requirement state, include the DC/DC converter 110, the inverter 21 for controlling the motor 102, and the voltage increasing converter 109, for example. The electronic members, which generate heat in the heat-increasing operation at the heat requirement state, may further include a motor driving the blower member 130 and the various electronic control units (ECU) or the like, in addition to the above. The electronic members may be operated by electrical power adjusted by a power element that is a switching power supply device, for example. The control device 120 controls the operation of a power element 111 so as to control the operation of the electronic members. For example, the control device 120 controls the supply of electrical power to the inverter 21, the supply of electrical voltage applied to the voltage increasing converter 109, the electrical conversion of the DC/DC converter 110, by controlling the operation of the power element 111.

Detection signals from various sensors for monitoring a cell state such as a voltage, a temperature or the like are inputted to a cell monitoring unit of the cell stack 101. The cell monitoring unit is configured to include a high-voltage battery signal detection portion, a low-voltage battery signal detection portion, and an inverter including a voltage increasing converter (voltage increasing portion). Temperature information, current information, voltage information, inner resistance information and environment temperature information and the like of the cell stack 101 are input to the high-voltage battery signal detection portion. On the other hand, temperature information, current information, voltage information, inner resistance information and environment temperature information and the like of the auxiliary battery (low voltage battery) are input to the low-voltage battery signal detection portion. The auxiliary battery is an example of auxiliary machine 104. The cell monitoring unit may be configured to include the DC/DC converter, or may be configured without including therein the DC/DC converter to be capable of communicating with a DC/DC converter arranged outside of the cell monitoring unit.

The inverter 21 is an electronic member configured to supply electrical power to the motor 102. The inverter 21 is adapted such that the electrical power supplied to the motor 102 is adjusted by the power element 111. The voltage increasing converter 109 is an electronic member that supplies an increased electrical voltage to the inverter 21. For example, the voltage increasing converter 109 increases the voltage from 300V to 600V, and the increased voltage is adjusted by a power element that is an example of the switching power supply device.

When the DC/DC converter 110 is used for controlling the charge and discharge of the cell modules of the cell stack 101, the DC/DC converter 110 is located between a high-voltage power supply portion and a low-voltage power supply portion. Here, the high-voltage power supply portion includes the cell stack 101 that is connected to a high voltage load such as the motor 102 to be capable of sending and receiving the electrical power. The high voltage load including the motor 102 can be used for power-generating and traveling of a hybrid vehicle. The low-voltage power supply portion includes the auxiliary battery (auxiliary machine) that supplies electrical power to a low voltage load. The DC/DC converter 110 is configured such that the electrical power conversion for the high voltage load such as the motor 102 and the electrical power conversion for the low voltage load can be adjusted by the power element 111 that is an example of the switching power supply device.

For example, the power element 111 is made of a transistor and a diode, and is a switching power source element capable of switching a part of an electrical circuit to convert and adjust the electrical power. The control device 120 can control at least one of the drive frequency and duty ratio input to the power element 111, thereby changing the level of output electrical voltage of the power element 111 to an electronic member. When electrical power is supplied from the cell stack 101 that is a high-voltage main battery (e.g., about 300V) to the auxiliary battery (e.g., 12V), the control device 120 generally controls the operation of the power element such that the efficiency of the power element 111 is about 90%.

At the heating request state, the control device 120 controls at least one of the drive frequency and duty ratio input to the power element 111, thereby causing the power element 111 to be in an inefficient control operation such that the efficiency of the power element is about 20%. Because of the inefficient control operation of the power element 111, the heat increasing operation is performed in the electronic member, and heat is radiated from the electronic member such as the inverter 21 and the DC/DC converter 110, thereby heating the cell stack 101 by using the generated heat.

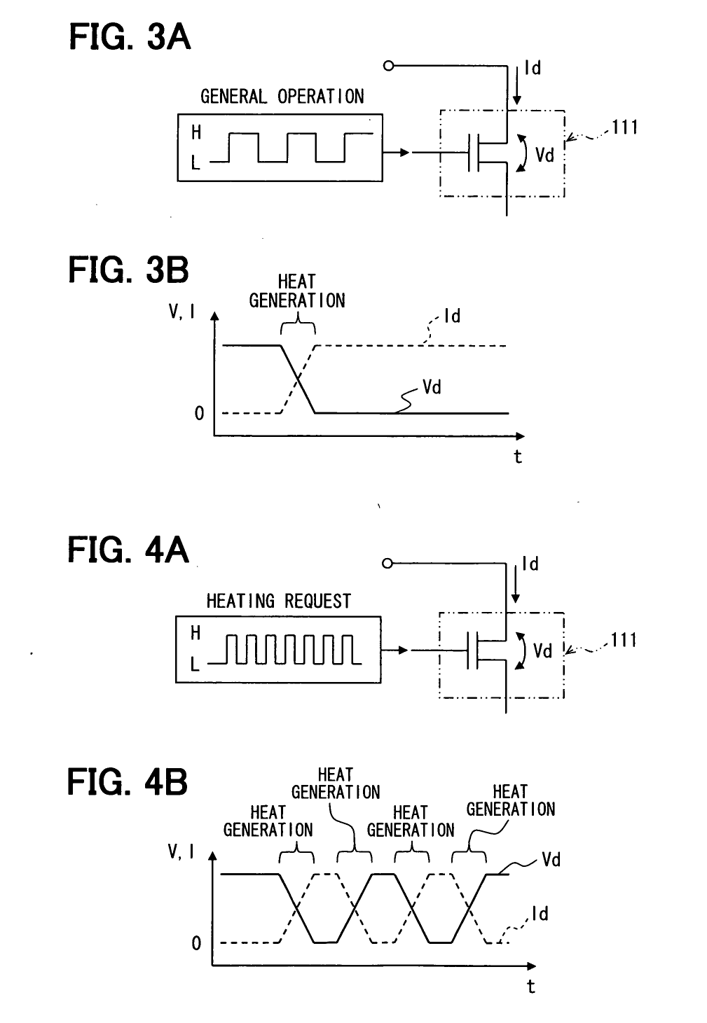

A first example of the heat increasing operation for increasing the heat amount generated from the electronic member such as the inverter 21 and the DC/DC converter 110 as compared with that in the general operation state will be described with reference to FIGS. 3A to 4B. FIGS. 3A and 3B show the control operation of the power element 111 in the general operation state in which the power element 111 is operated with the priority of efficiency. Specifically, FIG. 3A is a schematic diagram showing a control signal inputted to the power element 111 (i.e., switching power supply device) in the general operation state, and FIG. 3B is a graph showing the shape of electrical current I and electrical voltage V applied to the power element 111, in the generation operation state. FIGS. 4A and 4B show a first example of the operation of the power element 111 for increasing the generated heat from the electronic member. FIG. 4A is a schematic diagram showing the first example of a control signal inputted to the power element 111 (i.e., switching power supply device) in a heat increasing operation, and FIG. 4B is a graph showing the wave shape of electrical current I and electrical voltage V applied to the power element 111, in the heat increasing operation.

In the general operation state in which the power element 111 is operated with the priority of efficiency, a control signal of a pulse wave shown in FIG. 3A is input to the power element 111 by the control device 120, and the voltage and current are changed as shown in FIG. 3B. As shown in FIG. 3B, in the transient state in which the voltage Vd and the current Id increase and decrease, heat is generated from the electronic member. In the general operation state shown in FIGS. 3A and 3B, the frequency of the pulse wave is reduced, so that the on/off switching time of the power element 111 can be made shorter relative to the total time. As a result, an average heat generating amount can be reduced.

At a low temperature state where the battery cannot be effectively operated, a heating may be required from at least one of a vehicle drive device operated to drive the vehicle, and from an air conditioning component operated for air-conditioning of the vehicle compartment. In this case, the heat increasing operation of the power element 111 is performed. In the heat increasing operation, a control signal of a pulse wave shown in FIG. 4A is input to the power element 111 by the control device 120, and the voltage and current applied to the power element 111 are changed as in FIG. 4B. During the heat increasing operation, a timing of transient between switching on and off of the power element 111 is constant, but the time of one frequency is shorter. Therefore, the ratio of heat generating time per unit time becomes larger, the number of heat generation and the total time of the heat generation are relatively increased. Thus, during the heat increasing operation, the heat generation amount of the electronic member including the power element 111 is increased as compared with the generation operation state, thereby sending the generated heat to a device (e.g., the cell stack 101) which needs a heating. As a result, the heating of the device (e.g., the cell stack 101) can be performed. The above control shown in FIGS. 4A and 4B is an example of the heat increasing operation, in which the time of each transient state and the number of transient states are controlled to be larger than that in the general operation state. However, any inefficient control operation for reducing the efficiency of the electronic member as compared with the general operation state can be used in the heat increasing operation of the power element 111.

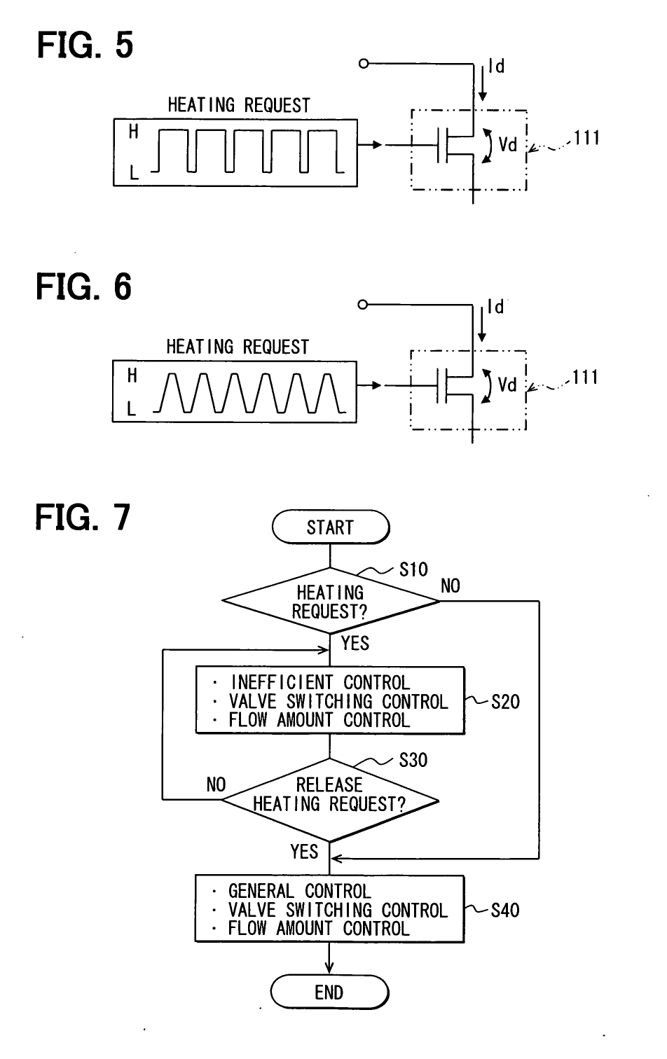

In the example shown in FIG. 5, when a heating is required from a device, the control device 120 increases a duty ratio inputted to the power element 111, instead of the increasing of the drive frequency inputted to the power element 111 shown in FIG. 4A. Even in the example shown in FIG. 5, the inefficient control operation of the electronic member including the power element 111 can be performed so as to increase the heat generated from the electronic member. Alternatively, by combining the increasing of the drive frequency and the increasing of the duty ratio inputted to the power element 111, the inefficient control operation of the electronic member including the power element 111 can be performed so as to increase the heat generated from the electronic member.

In the example of FIG. 5, the wave shape of the pulse signal inputted to the power element 111 is a rectangular wave shape in the heat increasing operation. However, the wave shape of the pulse signal inputted to the power element 111 may be a trapezoid wave shape in the heat increasing operation, as shown in FIG. 6. Even in the example shown in FIG. 6, the inefficient control operation of the electronic member including the power element 111 can be performed so as to increase the heat generated from the electronic member. In the wave-shaped signal inputted to the power element 111 shown in FIG. 6, the rising time and the dropping time of the switching are made longer as compared with the example shown in FIG. 5. In the wave-shaped signal of FIG. 6, the time of the transient state in which the voltage or the current increases or decreases can be made longer, thereby elongating the heat-generating time and facilitating heat generation of the electronic member.

As another example of the heat increasing operation, at least one of the current and the voltage outputted by the switching power supply device may be controlled larger by the control device 120, as compared with the general operation state. The heat increasing operation is an operation of increasing the load applied to the switching power supply device, as compared with the general operation state. In this case, the output current value or the output voltage value to the electronic member is controlled by the control device 120 to be larger than the output current value or the output voltage value in the general operation state. Even in this case, the inefficient control operation of the electronic member including the power element 111 can be performed so as to increase the heat generated from the electronic member. At least two of the above-described inefficient control operations in the electronic member may be combined, thereby further increasing the heat generation amount of the electronic member and improving heating capacity of a device having a heating request.

Next, a control operation of the thermal management system at the heating request state will be described with reference to FIG. 7. FIG. 7 is a flow diagram showing the control operation at the heating request state of the thermal management system, performed by the control device 120.

When a power source of the control device 120 is turned on, it is determined whether there is a heating request from devices including at least one of vehicle-driving devices and an air-conditioning device, at step S10. The vehicle-driving devices are devices used for the traveling of the vehicle, and include the engine 11, the motor 102 and the fuel cell stack 101, for example. The air-conditioning device is used for the air-conditioning in the vehicle compartment 40, and include components of a refrigerant cycle for air-conditioning and the heater core 13, for example. Generally, the heating is required, when the vehicle-driving device or the air-conditioning device is in a low temperature state and is difficult to sufficiently perform its function. The low temperature state can be detected by a detection unit, and a heating request signal is sent to the control device 120 from the detection unit. Then, the control device 120 determines whether the heating is necessary based on the signal from the detection unit.

An example of a heating request from the cell stack 101 will be described with reference to FIG. 7. First, information regarding respective cell modules in the cell stack 101 are input to the control device 120, so as to detect a cell temperature Td. Then, it is determined whether the cell temperature Td is lower than a predetermined temperature T1. When the cell temperature Td of the cell stack 101 is not lower than the predetermined temperature T1, it is determined that a heating is not requested at step S10, and a general temperature control is performed at step S40. In the general temperature control of the cell stack 101, the temperature of the cell modules of the cell stack 101 are controlled in a predetermined temperature range so that the cell modules can be effectively operated. For example, the control device 120 controls the passage adjusting devices 14, 25 so as to control a coolant flow, controls output of the pumps 12, 22 so as to control the flow amount in the coolant flow, and controls operation of the blower member 130. After the general temperature control is performed, the control process returns to step S10, and the process of the following steps is performed. In the general temperature control of the cell stack 101, air is blown to the cell stack 101 by the blower member 130, so as to control (cool) the temperature of the respective cell modules to be in a predetermined range. Accordingly, the cell modules of the cell stack 101 can be efficiently operated.

In contrast, when the cell temperature Td is lower than the predetermined temperature T1 at step S10, the control device 120 determines that there is a heating request from the cell stack 101, and causes the power element 111 (i.e., switching power supply device) to be operated in the heat increasing operation. That is, the power element 111 that adjusts the electrical power output to the electronic member is inefficiently operated at step S20 so as to increase the heat generation from the electronic member. For example, in the inefficient control operation, the drive frequency or/and the duty ratio applied to the power element 111 is increased, or/and the rising time and the like of the switching of the input signal of the power element 111 can be increased. Accordingly, the number of the transient states with the variation of the current and the voltage or/and the entire time of the transient states with the variation of the current and the voltage can be larger than that in the general operation state. Thus, the heat generating number or/and the average heat generating amount in the electronic member can be increased as compared with the general operation time, thereby increasing heat radiation amount to the exterior and also increasing heat generation amount of the electronic member such as the inverter 21.

Furthermore, at step S20, the passage adjusting device 25 is controlled so that the coolant flowing out of the inverter 21 flows into the bypass passage 29 in the second coolant circuit 20, and the passage adjusting device 14 is controlled so that the coolant flowing out of the heater core 13 flows into the bypass passage 18. Furthermore, the thermostat 23 is controlled so that the coolant flowing to the second coolant circuit 20 from the bypass passage 18 flows through the bypass passage 26. Thus, heat generated purposefully from the electronic member (e.g., inverter 21) is transferred to the coolant, and radiated to exterior air in the heater core 13 via the bypass passage 29. Thus, air blown into the heater core 13 is heated, and the heated air is sent by the blower member 130 to the cell stack 101. As a result, the temperature in the respective cell modules is increased, and heating of the cell stack 101 can be performed.

The heat increasing operation of step S20 is performed continuously until the heating request is released. That is, until it is determined that the cell temperature Td is not lower than the predetermined temperature T1 at step S30, the heat increasing operation of step S20 is performed continuously. When the cell temperature Td is not lower than the predetermined temperature T1 at step S30, the heating is unnecessary to be performed, thereby ending the heat increasing operation and performing the general temperature control at step S40.

Next, the operation of the components of the thermal management system and the heat generation from the thermal management system, when a heating is required from a component other than the cell stack 101, will be described with reference to FIG. 1.

When a heating is required from the engine 11, the control device 120 causes the power element 111 of the inverter 21 to be operated in the heat increasing operation. At the heating request state of the engine 11, the passage adjusting device 25 is controlled so that the coolant flowing out of the inverter 21 flows into the bypass passage 27 in the second coolant circuit 20 so as to flow into the engine 11, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to the engine 11 via the bypass passage 27. Then, the coolant flows through the heater core 13, the bypass passage 18 and the bypass passage 26 in this order, and returns to the inverter 21. The coolant is continuously circulated in the above coolant cycle, so as to transfer heat from the electronic member (e.g., inverter 21) to the engine 11. As a result, the temperature of the engine 11 is increased, and heating of the engine 11 can be performed.

When a heating is required from the motor 102 for a vehicle traveling, the control device 120 causes the power element 111 of the inverter 21 to be operated in the heat increasing operation. At the heating request state of the motor 102, the passage adjusting device 25 is controlled so that the coolant flowing out of the inverter 21 flows into the coolant passage 28 in the second coolant circuit 20, and the thermostat 23 is controlled so that the coolant flowing out of the motor 102 flows through the bypass passage 26. Thus, heat generated purposefully from the inverter 21 is transferred to the coolant, and is radiated to the motor 102 via the coolant passage 28. The coolant circulates the motor 102, the bypass passage 26 and the inverter 21 in this order. The coolant is continuously circulated in the above coolant cycle, so as to transfer heat from the inverter 21 to the motor 102. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation. At the heating request state of the heater core 13, the passage adjusting device 25 is controlled so that the coolant flowing out of the inverter 21 flows into the bypass passage 29 in the second coolant circuit 20, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to air in the heater core 13 via the bypass passage 29. Then, the coolant flows through the heater core 13, the bypass passage 18 and the bypass passage 26 in this order, and returns to the inverter 21. The coolant is continuously circulated in the above coolant cycle, so as to transfer heat from the inverter 21 to the heater core 13, thereby heating air passing through the heater core 13. As a result, the heat radiation amount from the coolant in the heater core 13 is increased, thereby improving heating capacity in the vehicle compartment.

Next, operation and advantages of the thermal management system according to the present embodiment will be described. The thermal management system is provided with electronic members, such as the inverter 21, the voltage increasing converter 109 and DC/DC converter 110, with an electrical output adjusted by the power element 111. The thermal management system is further provided with the control device 120 which controls operation of the power element 111 so as to control the operation of the electronic members. When the control device 120 receives a heating request from any one of the vehicle driving device for driving the vehicle and the air conditioning device operated for air-conditioning of the vehicle compartment, the control device 120 causes the power element 111 to be operated in the heat increasing operation, thereby increasing the generated heat from the electronic members. The generated heat is supplied to the device having the heating request.

When the control device 120 receives the heating request from the device, the power element 111 (switching power supply device) is operated with the heat increasing operation, so that the heat generation amount of the electronic member(s) is increased as compared with the general operation state. Thus, the heat generated purposefully in the heat increasing operation can be supplied to the device having a heating request, such as a vehicle driving device and an air conditioning device. Therefore, the heating of the device can be performed effectively by using the electronic members existing in the vehicle. That is, a thermal using cycle using the heat generated in the vehicle can be formed in the thermal management system so that the heating can be performed without using a special heating machine. Furthermore, the electronic members that are necessary for the vehicle are operated with the heat increasing operation to purposefully generate heat. Therefore, the time of idling-up request in the vehicle can be reduced, thereby improving fuel consumption performance in the vehicle.

The control device 120 performs the inefficient control operation as the heat increasing operation, in which the number of the transient states where the current and the voltage increase or decrease or/and the time of the transient state are set to be larger as compared with the general operation state. In the inefficient control operation, the power element 111 (switching power supply device) is operated such that the number of the transient states or/and the time of the transient states are set to be larger than that in the general operation state, so as to increase switching loss and conductive loss of the electronic member than that of the general operation state. Thus, heat generated from the electronic member can be increased. By controlling the operation of the existing electronic member, the heating, due to the thermal management system can be effectively increased, and the heating of the device having the heating request can be facilitated. The switching loss is a loss generated while a built-in transistor is transient from on to off or transient from off to on, and the conductive loss is a loss after the transistor is completely turned on.

The control device 120 performs the inefficient control operation so as to increase heat generation from the electronic member(s), by inputting a control signal for increasing at least one of the drive frequency and duty ratio to the switching power supply device, as compared with the generation operation state.

In the heat increasing operation, the switching loss and the conductive loss of the electronic member are increased than that of the general operation state. Thus, heat generated from the electronic member can be increased. By controlling the operation of the existing electronic member, the heating due to the thermal management system can be accurately increased, and the heating of a device having a heating request can be facilitated.

The control device 120 performs the heat increasing operation such that at least one of the current and the voltage applied to the power element 111 is made larger than that in the general operation state. In the heat increasing operation, the power element 111 (switching power supply device) is operated such that at least one of the current and the voltage is made larger than the general operation state, so as to increase switching loss and conductive loss of the electronic member than that of the general operation state. Thus, heat generated from the electronic member can be increased. By controlling the operation of the existing electronic member, the heating due to the thermal management system can be accurately increased, and the heating of a device having a heating request can be facilitated.

The electronic member is, for example, at least one of the inverter 21, the voltage increasing converter 109 and DC/DC converter 110 which existing in the vehicle. Thus, it is unnecessary to provide a new special heating machine, thereby reducing the mounting space and cost of the thermal management system. Plural electronic members for generating heat can be suitably combined in accordance with the heat quantity required in the heating, thereby effectively using the generated heat.

For example, the vehicle drive device receiving the supply of heat generated by the heat increasing operation at the heating request state may be the cell stack 101 that can supply electrical power to the motor 102 used as a drive source for the vehicle running. In this case, heat generated by the heat increasing operation of the switching power supply device can be effectively used for the cell stack 101. Therefore, at a low temperature of the cell stack 101, the interior resistance of the cell stack 101 can be reduced, so as to prevent a shortage of the current or voltage in the discharging of the battery and prevent supercharge of the voltage in the charging of the battery. As a result, a battery damage of the cell stack 101 can be reduced.

The vehicle drive device receiving the supply of heat generated by the heat increasing operation at the heating request state may be the vehicle engine 11. In this case, heat generated by the heat increasing operation of the switching power supply device can be supplied to the vehicle engine 11. Therefore, both the fuel consumption efficiency and the vehicle driving performance can be improved at a low cost.

The vehicle drive device receiving the supply of heat by the heat increasing operation at the heating request state may be the motor 102 used as a drive source for the vehicle running. In this case, heat generated by the heat increasing operation of the switching power supply device can be supplied to the motor 102. Thus, the motor 102 can be operated with a predetermined performance, thereby improving power performance, fuel consumption efficiency and running performance in a vehicle such as a hybrid vehicle, an electrical vehicle, a fuel cell vehicle or the like, at a low cost.

The air conditioning device receiving the supply of heat by the heat increasing operation at the heating request state is the heater core 13 that heats air to be blown into the vehicle compartment. In this case, heat generated by the heat increasing operation of the switching power supply device can be supplied to the heater core 13. Therefore, air conditioning performance can be effectively improved with a low cost.

The thermal management system includes the cell stack 101, the motor 102, the engine 11 and the heater core 13, which are used as the device capable of performing the heating thereof by using the generated heat in the heat increasing operation. Thus, the generated heat can be effectively used for various devices in the vehicle at a low cost.

In the present embodiment, both the electronic member (e.g., inverter 21) that generates heat in the heat increasing operation and the motor 102 that requests the heating are provided to perform heat exchange with the coolant in the same coolant circuit in which the coolant circulates. Thus, heat generated from the electronic member (e.g., inverter 21) by the heat increasing operation is supplied to the motor 102 having the heating request by using the coolant as a thermal transmission medium. Accordingly, a thermal supply path is provided through the coolant of the same coolant circuit in which the motor 102 and the electronic member are arranged. Therefore, the thermal management system can perform the heating of the motor 102 with a simple structure using the coolant circuit of one system.

Furthermore, the electronic member (e.g., inverter 21) that generates heat in the heat increasing operation and the devices (e.g., engine 11, heater core 13) that request the heating are provided to perform heat exchange with the coolant in the separate coolant circuits (10, 20) in which the coolant circulates respectively. The control device 120 controls the passage adjusting device 25 so that the second coolant circuit 20 in which the electronic member (e.g., inverter 21) is arranged is connected to the first coolant circuit 10 in which the device (11, 13) having the heating request is arranged. Thus, heat generated from the electronic member by the heat increasing operation is supplied to the device having the heating request by using the coolant as a thermal transmission medium. Accordingly, the electronic member can be selectively connected to the devices provided in the separate coolant circuits through coolant path with the heating request. Therefore, the thermal management system can perform the heating by combining coolant circuits of plural systems.

When the control device 120 receives a heating request from the cell stack 101, the control device 120 causes the heater core 13 and the electronic member (e.g., inverter 21) to communicate with each other via a coolant circuit. Thus, heat generated by the heat increasing operation of the electronic member (e.g., inverter 21) is transmitted to air via the coolant in the heater core 13, and the heated air used as the thermal medium is transmitted to the cell stack 101 as the high-voltage battery.

Accordingly, the heat supply amount to the battery can be increased by using a thermal transmission via the coolant and a thermal transmission via air.

### Second Embodiment

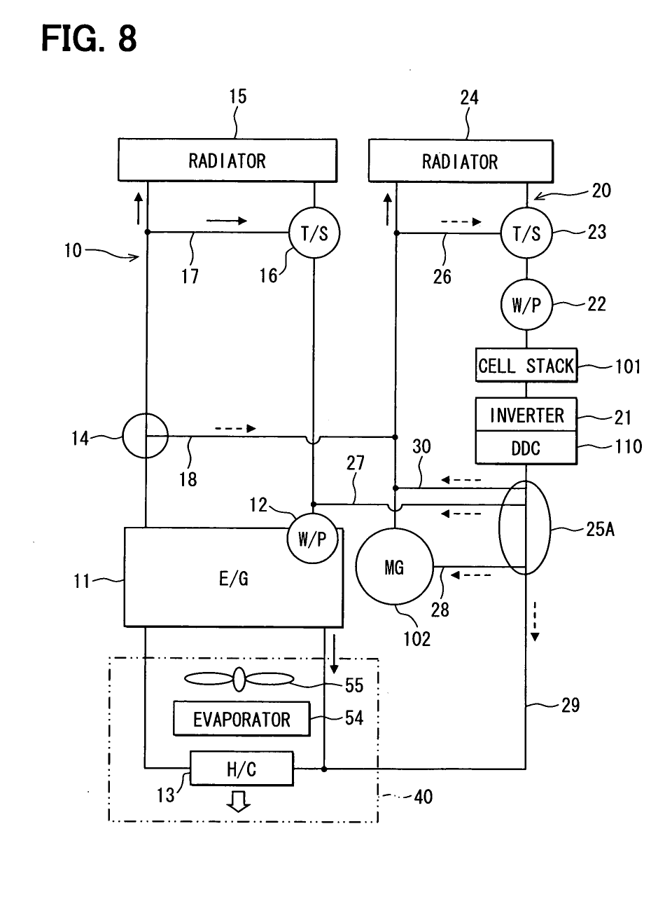

A second embodiment of the present invention will be described with reference to FIG. 8. FIG. 8 shows a thermal management system according to the second embodiment. In FIG. 8, the parts similar to or corresponding to those of the thermal management system of the first embodiment are indicated by the same reference numbers, and the detail explanation thereof is omitted.

In the above described thermal management system of the first embodiment, the heating of the cell stack 101 is performed by using air heated by the coolant in the heater core 13. In contrast, in the thermal management system of the second embodiment, the cell stack 101 is located in a second coolant circuit 20 such that the cell stack 101 can be directly cooled by the coolant. Specifically, the cell stack 101 is provided in the second coolant circuit 20, such that the coolant circulating in the second coolant circuit 20 is heat-exchanged with the cell stack 101.

Furthermore, a bypass passage 30 is branched from the second coolant circuit 20 in addition to the bypass passage 27, the coolant passage 28 and the bypass passage 29, such that the coolant flowing out of the inverter 21 flows toward a side of the radiator 24 while bypassing the motor 102. A passage adjusting device 25A is located in the second coolant circuit 20, so as to adjust a flow ratio of the coolant flowing to the motor 102, to the heater core 13, to the engine 11 and to a side of the stack 101 (or a side of the bypass passage 26) among the coolant amount flowing from the inverter 21, to be respectively in a range from 0% to 100%. That is, the passage adjusting device 25A can switch the flow of the coolant from the inverter 21 to any one of the side of the motor 102, the side of the heater core 13, the side of the engine 11 and the side of the cell stack 101. The passage adjusting device 25A can be configured by a flow adjusting valve, a flow switching valve or the like.

Next, operation of the thermal management system of the present embodiment, when a heating is required from respective devices, will be described with reference to FIG. 8.

When a heating is required from the cell stack 101, the control device 120 causes the power element 111 of the inverter 21 to be operated in the heat increasing operation. At the heating request state of the cell stack 101, the passage adjusting device 25A is controlled so that the coolant flowing out of the inverter 21 flows into the bypass passage 30 while bypassing the motor 102 in the second coolant circuit 20, and the thermostat 23 is controlled so that the coolant flowing to the bypass passage 30 flows through the bypass passage 26. Thus, heat generated purposefully from the inverter 21 is transferred to the coolant, and is radiated to the cell stack 101 via the bypass passage 30 and the bypass passage 26. Thus, the coolant circulates between the inverter 21 and the cell stack 101 without flowing into the motor 102 and the radiator 24, so as to effectively transfer heat from the inverter 21 to the cell stack 101. As a result, the temperature in the cell stack 101 is increased, and heating of the cell stack 101 can be continuously performed.

When a heating is required from the engine 11, the control device 120 causes the power element 111 of the inverter 21 to be operated in the heat increasing operation. At the heating request state of the engine 11, the passage adjusting device 25A is controlled so that the coolant flowing out of the inverter 21 flows into the bypass passage 27 in the second coolant circuit 20 so as to flow into the engine 11, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to the engine 11 via the bypass passage 27. The coolant from the engine 11 flows through the heater core 13, the bypass passage 18 and the bypass passage 26 in this order, and returns to the inverter 21. The coolant is continuously circulated in the above coolant cycle, so as to transfer heat from the inverter 21 to the engine 11. As a result, the temperature in the engine 11 is increased, and heating of the engine 11 can be effectively performed.

When a heating is required from the motor 102 for a vehicle traveling, the control device 120 causes the power element 111 of the inverter 21 to be operated in the heat increasing operation. At the heating request state of the motor 102, the passage adjusting device 25A is controlled so that the coolant flowing out of the inverter 21 flows into the coolant passage 28 in the second coolant circuit 20, and the thermostat 23 is controlled so that the coolant flowing out of the motor 102 flows through the bypass passage 26. Thus, heat generated purposefully from the inverter 21 is transferred to the coolant, and is radiated to the motor 102 via the coolant passage 28. The coolant circulates the motor 102, the bypass passage 26 and the inverter 21 in this order. The coolant is continuously circulated in the above coolant cycle, so as to transfer heat from the inverter 21 to the motor 102. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation. At the heating request state of the heater core 13, the passage adjusting device 25A is controlled so that the coolant flowing out of the inverter 21 flows into the bypass passage 29 in the second coolant circuit 20, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to air in the heater core 13 via the bypass passage 29. Then, the coolant flows through the heater core 13, the bypass passage 18 and the bypass passage 26 in this order, and returns to the inverter 21. The coolant is continuously circulated in the above coolant cycle, so as to transfer heat from the inverter 21 to the heater core 13, thereby effectively heating air passing through the heater core 13. As a result, the heat radiation amount from the coolant in the heater core 13 is increased, thereby improving heating capacity in the vehicle compartment.

Next, operation and effects of the thermal management system according to the second embodiment will be described. The thermal management system includes the cell stack 101, the motor 102, the engine 11 and the heater core 13, which are used as the devices capable of performing the heating thereof by using the generated heat of the electronic member in the heat increasing operation. Thus, the generated heat can be effectively used for various devices in the vehicle.

In the present embodiment, both the electronic member (e.g., inverter 21) that generates heat in the heat increasing operation and the device (e.g., the motor 102 and cell stack 101) that requests the heating are provided to perform heat exchange with the coolant in the same coolant circuit in which the coolant circulates. Thus, heat generated from the electronic member by the heat increasing operation is supplied to the motor 102 or the cell stack 101 with the heating request, by using the coolant as a thermal transmission medium. Accordingly, a thermal supply path is provided through the coolant of the same coolant circuit in which the motor 102, the cell stack 101 and the electronic member are arranged. Therefore, the thermal management system can perform the heating of the motor 102 or the cell stack 101 with a simple structure by using the coolant circuit of one system.

### Third Embodiment

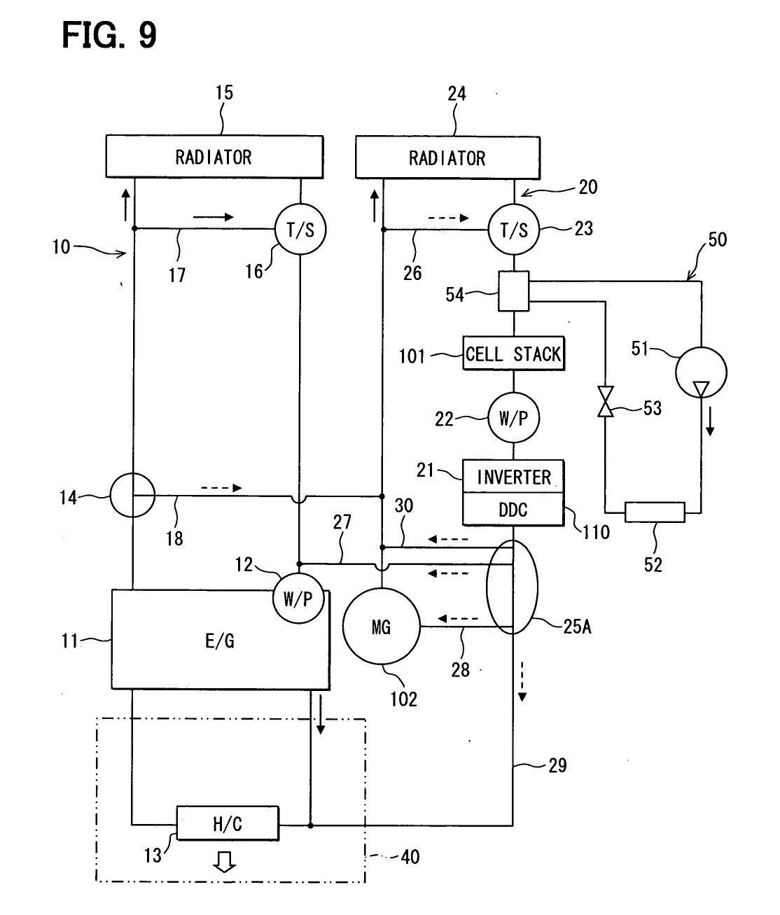

A third embodiment of the present invention will be described with reference to FIG. 9. FIG. 9 shows a thermal management system according to the third embodiment. In FIG. 9, the parts similar to or corresponding to those of the thermal management system of the first embodiment or the second embodiment are indicated by the same reference numbers, and the detail explanation, thereof is omitted.

In the thermal management system of the third embodiment, the cell stack 101 is located in the second coolant circuit 20 such that the cell stack 101 can be directly cooled by the coolant, similarly to the second embodiment. That is, the cell stack 101 is provided in the second coolant circuit 20, such that the coolant circulating in the second coolant circuit 20 is heat-exchanged with the cell stack 101. Furthermore, as shown in FIG. 9, a coolant passage is further added in the second coolant circuit 20 to be adjacent to a refrigerant passage of the evaporator 54, upon the thermal management system of the second embodiment. The evaporator 54 is a component of a refrigerant cycle for a vehicle air conditioner. The evaporator 54 is located in the second coolant circuit 20 such that refrigerant flowing through the refrigerant passage of the evaporator 54 is heat-exchanged with the coolant flowing in the coolant passage of the evaporator 54, in the second coolant circuit 20. The refrigerant cycle 50 further includes a compressor 51 for compressing and discharging high-pressure refrigerant, a condenser 52 for cooling and condensing the refrigerant flowing from the compressor 51, and a decompression device 53 for decompressing the refrigerant flowing from the condenser 52, in addition to the evaporator 54. The compressor 51, the condenser 52, the decompression device 53 and the evaporator 54 are connected in this order by using piping so as to form the refrigerant cycle 50.

Furthermore, the bypass passage 30 is branched from the second coolant circuit 20 in addition to the bypass passage 27, the coolant passage 28 and the bypass passage 29, such that the coolant flowing out of the inverter 21 flows toward the side of the radiator 24 while bypassing the motor 102. The passage adjusting device 25A is located in the second coolant circuit 20, so as to adjust a flow ratio of the coolant flowing to the motor 102, to the heater core 13, to the engine 11 and to a side of the stack 101 (i.e., a side of the coolant passage 26) among the coolant amount flowing from the inverter 21, to be respectively in a range from 0% to 100%. That is, the passage adjusting device 25A can switch the flow of the coolant from the inverter 21 to any one of the side of the motor 102, the side of the heater core 13, the side of the engine 11 and the side of the cell stack 101.

In the third embodiment, the evaporator 54 is located in the air conditioning case of the vehicle air conditioner, and the heater core 13 is located downstream of the evaporator 54 in the air flow so that air having passed through the evaporator 54 by the blower 55 passes through the heater core 13.

Next, operation of the thermal management system of the present embodiment, when heating is required from respective devices, will be described with reference to FIG. 9.

When a heating is required from the cell stack 101, the control device 120 causes the power element 111 of the inverter 21 to be operated in the heat increasing operation. At the heating request state of the cell stack 101, the passage adjusting device 25A is controlled so that the coolant flowing out of the inverter 21 flows into the bypass passage 30 while bypassing the motor 102 in the second coolant circuit 20, and the thermostat 23 is controlled so that the coolant flowing to the bypass passage 30 flows through the bypass passage 26. Thus, heat generated purposefully from the inverter 21 is transferred to the coolant, and is radiated to the cell stack 101 via the bypass passage 30 and the bypass passage 26. Thus, the coolant circulates between the inverter 21 and the cell stack 101 without flowing into the motor 102 and the radiator 24, so as to effectively transfer heat from the inverter 21 to the cell stack 101. As a result, the temperature in the cell stack 101 is increased, and heating of the cell stack 101 can be continuously performed.

When a heating is required from the refrigerant cycle 50, the control device 120 causes the power element 111 of the inverter 21 to be operated in the heat increasing operation. At the heating request state of the refrigerant cycle 50, the passage adjusting device 25A is controlled so that the coolant flowing out of the inverter 21 flows into the bypass passage 30 while bypassing the motor 102 in the second coolant circuit 20, and the thermostat 23 is controlled so that the coolant flowing to the bypass passage 30 flows through the bypass passage 26. In the heating of the refrigerant cycle 50, refrigerant circulates in the refrigerant cycle 50. Thus, heat generated purposefully from the inverter 21 is transferred to the coolant, and is radiated to the refrigerant in the evaporator 54 via the bypass passage 30 and the bypass passage 26. Therefore, the refrigerant in the evaporator 54 is heated, thereby facilitating heat radiation of a low-pressure refrigerant flowing from the refrigerant outlet of the decompression device 53 to a refrigerant suction port of the compressor 51, and increasing heating operation of the vehicle compartment. In the third embodiment, the coolant flowing out of the inverter 21 returns to the inverter 21 without flowing through the motor 102 and the radiator 24, so as to effectively transfer heat from the inverter 21 to the refrigerant cycle 50. As a result, the temperature of the refrigerant in the evaporator 54 is increased, and heating of the refrigerant cycle 50 can be continuously performed.

The arrangement position of the evaporator 54 may be changed by the condenser 52, in the example of FIG. 9. That is, the condenser 52 may be located in the second coolant circuit 20, instead of the evaporator 54. In this case, heat generated purposefully from the inverter 21 is transferred to the coolant, and is radiated to the refrigerant in the condenser 52 via the bypass passage 30 and the bypass passage 26. Therefore, the refrigerant in the condenser 52 is heated, thereby facilitating heat radiation of a high-pressure refrigerant discharged from the compressor 51 in the refrigerant cycle 50, and increasing heating operation of the vehicle compartment.

The coolant of the second coolant circuit 20 may be circulated in the second coolant circuit 20 while passing through the radiator 24, without performing the heat increasing operation. When the condenser 52 is located in the second coolant circuit 20, the coolant of the second coolant circuit 20 is cooled in the radiator 24 to be heat-radiated, so that the refrigerant in the refrigerant cycle 50 can be cooled in the condenser 52 via the second coolant circuit 20. Thus, the cooling of the high-pressure refrigerant of the refrigerant cycle 50 can be facilitated.

When a heating is required from the engine 11, the control device 120 causes the power element 111 of the inverter 21 to be operated in the heat increasing operation, similarly to the second embodiment. At the heating request state of the engine 11, the passage adjusting device 25A is controlled so that the coolant flowing out of the inverter 21 flows into the bypass passage 27 in the second coolant circuit 20 so as to flow into the engine 11, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to the engine 11 via the bypass passage 27. The coolant from the engine 11 flows through the heater core 13, the bypass passage 18 and the bypass passage 26 in this order, and returns to the inverter 21. The coolant is continuously circulated in the above coolant cycle, so as to transfer heat from the inverter 21 to the engine 11. As a result, the temperature in the engine 11 is increased, and heating of the engine 11 can be effectively performed.

When a heating is required from the motor 102 for a vehicle traveling, the control device 120 causes the power element 111 of the inverter 21 to be operated in the heat increasing operation, similarly to the second embodiment. At the heating request state of the motor 102, the passage adjusting device 25A is controlled so that the coolant flowing out of the inverter 21 flows into the coolant passage 28 in the second coolant circuit 20, and the thermostat 23 is controlled so that the coolant flowing out of the motor 102 flows through the bypass passage 26. Thus, heat generated purposefully from the inverter 21 is transferred to the coolant, and is radiated to the motor 102 via the coolant passage 28. The coolant circulates the motor 102, the bypass passage 26 and the inverter 21 in this order. The coolant is continuously circulated in the above coolant cycle, so as to transfer heat from the inverter 21 to the motor 102. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation, similarly to the second embodiment. At the heating request state of the heater core 13, the passage adjusting device 25A is controlled so that the coolant flowing out of the inverter 21 flows into the bypass passage 29 in the second coolant circuit 20, and the passage adjusting device 14 is controlled so that the coolant flowing out of the heater core 13 in the first coolant circuit 10 flows into the bypass passage 18. Furthermore, the thermostat 23 is controlled so that the coolant flowing to the second coolant circuit 20 from the bypass passage 18 flows through the bypass passage 26. Thus, heat generated purposefully from the inverter 21 is transferred to the coolant, and is radiated to air in the heater core 13 via the bypass passage 29. Then, the coolant flows through the heater core 13, the bypass passage 18 and the bypass passage 26 in this order, and returns to the inverter 21. The coolant is continuously circulated in the above coolant cycle, so as to transfer heat from the inverter 21 to the heater core 13, thereby effectively heating air passing through the heater core 13. As a result, the heat radiation amount from the coolant in the heater core 13 is increased, thereby improving heating capacity in the vehicle compartment.

Next, operation and effects of the thermal management system according to the third embodiment will be described. The thermal management system includes the component of the refrigerant cycle 50, in addition to the cell stack 101, the motor 102, the engine 11 and the heater core 13, which are used as the devices capable of performing the heating thereof by using the generated heat of the electronic member in the heat increasing operation. Thus, the generated heat can be effectively used for various devices including the refrigerant cycle 50 in the vehicle. When the heating is required from the refrigerant cycle 50, the control device 120 causes the switching power supply device to generate heat, thereby supplying the generated heat to the refrigerant cycle 50.

According to the present embodiment, because the heat generated due to the heat increasing operation of the switching power supply device can be supplied to the refrigerant cycle 50, the performance of the refrigerant cycle 50 can be improved. Thus, heat generated in the vehicle can be effectively used for the air conditioning of the vehicle compartment.

The thermal management system includes the components of the refrigerant cycle 50, the cell stack 101, the motor 102, the engine 11 and the heater core 13, which are used as the devices capable of performing the heating thereof by using the generated heat in the heat increasing operation. Thus, the generated heat can be effectively used for various devices in the vehicle.

In the present embodiment, both the electronic member (e.g., inverter 21) that generates heat in the heat increasing operation and the device (e.g., the motor 102, the cell stack 101, the refrigerant cycle 50 including the evaporator 54 and the condenser 52) that requests the heating are provided to perform heat exchange with the coolant in the same coolant circuit in which the coolant circulates. Thus, heat generated from the electronic member by the heat increasing operation is, supplied to the motor 102, the cell stack 101 and the refrigerant cycle 50 with the heating request, by using the coolant as a thermal transmission medium. Accordingly, a thermal supply path is provided through the coolant of the same coolant circuit in which the motor 102, the cell stack 101, the refrigerant cycle 50 and the electronic member are arranged. Therefore, the thermal management system can perform the heating of the motor 102, the cell stack 101 or the refrigerant cycle 50 with a simple structure, by using the coolant circuit of one system.

### Fourth Embodiment

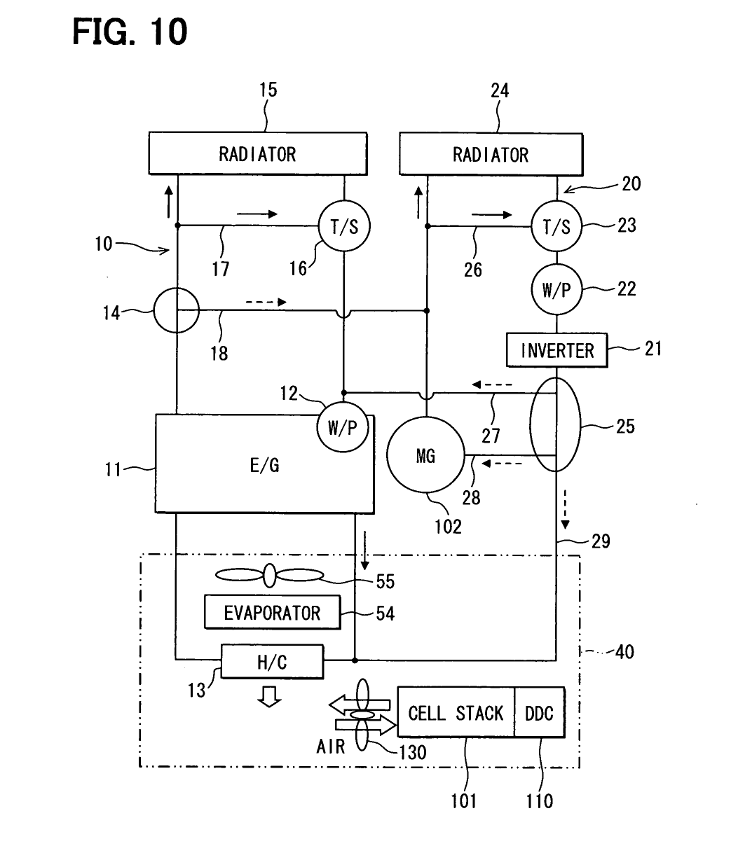

A fourth embodiment of the present invention will be described with reference to FIG. 10. FIG. 10 shows a thermal management system according to the fourth embodiment. In FIG. 10, the parts similar to or corresponding to those of the thermal management system of the first embodiment are indicated by the same reference numbers, and the detail explanation thereof is omitted.

In the thermal management system of the fourth embodiment, as shown in FIG. 10, the DC/DC converter 110 is located adjacent to the cell stack 101 or located integrally with the cell stack 101, as compared with the thermal management system of the first embodiment. The DC/DC converter 110 is configured to generate heat in the heat increasing operation, so that the heat generated from the DC/DC converter 110 can be effectively used for the heating of the cell stack 101 adjacent to the DC/DC converter 110.

Operation and effects of the thermal management system according to the fourth embodiment will be described with reference to FIG. 10.

When the control device 120 receives a heating request of the cell stack 101, the control device 120 causes the power element within the DC/DC converter 110 to be operated in the heat increasing operation. At the heating request state of the cell stack 101, the blower member 130 is controlled by the control device 120 so as to blow air to the cell stack 101 from a side of the DC/DC converter 110. Specifically, the control device 120 controls the fan rotation speed and the fan rotation direction of the blower member 130, so that heat generated purposefully from the DC/DC converter 110 is transferred to the cell stack 101, and is radiated to the cell stack 101 via the air. Thus, the temperature in the cell stack 101 is increased by the generated heat, and heating of the cell stack 101 can be effectively performed.

When the heating of the cell stack 101 is performed, the heat increasing operation can be also performed in the power element 111 of the inverter 21, in addition to the heat increasing operation of the power element of the DC/DC converter 110. In this case, the passage adjusting device 25 is controlled by the control device 120 so that the coolant flowing out of the inverter 21 flows into the bypass passage 29 in the second coolant circuit 20, and the passage adjusting device 14 is controlled by the control device 120 so that the coolant flowing out of the heater core 13 flows into the bypass passage 18. Furthermore, the thermostat 23 is controlled, so that the coolant flowing to the second coolant circuit 20 from the bypass passage 18 flows through the bypass passage 26, and returns to the inverter 21.

Thus, heat generated purposefully from the inverter 21 is transferred to the coolant, and radiated to exterior air in the heater core 13 via the bypass passage 29. Thus, air blown into the heater core 13 by the blower member 55 is heated, and the heated air is sent to the cell stack 101. As a result, the temperature in the respective cell modules of the cell stack 101 is increased by using both of the heat from the DC/DC converter 110 adjacent to the cell stack 101 and the heat from the inverter 21, and thereby the heating of the cell stack 101 can be facilitated.

When a heating is required from the engine 11, the control device 120 performs the control of the thermal management system similarly to the first embodiment, and thereby the operation and effects similar to the first embodiment can be obtained.

When a heating is required from the motor 102 for a vehicle traveling, the control device 120 performs the control of the thermal management system similarly to the first embodiment, and thereby the operation and effects similar to the first embodiment can be obtained.

When a heating is required from the heater core 13, the control device 120 performs the control of the thermal management system similarly to the first embodiment, and thereby the operation and effects similar to the first embodiment can be obtained.

According to the thermal management system of the present embodiment, the air blowing direction of the blower member 130 can be set to be switched between a first direction (i.e., an air blowing direction for cooling the cell stack) and a second direction (i.e., an air blowing direction for heating the cell stack), so as to adjust the temperature of the cell stack 101. Accordingly, the cooling and the heating of the cell stack 101 can be performed, in addition to the heat increasing operation of the power element of the DC/DC converter 110 and the heat increasing operation of the power element 111 of the inverter 21. Thus, the heating and the cooling of the battery such as the cell stack 101 can be suitably performed, thereby improving the fuel consumption efficiency with a low cost.

Even in the thermal management system of the present embodiment, when the heating is required from the cell stack 101, the first coolant circuit 10 is connected to the second coolant circuit 20, so that the heat generated from the inverter 21 is transmitted to the heater core 13 via the coolant. Thus, the heat generated from the power element of the inverter 21 can be transmitted to air in the heater core 13, and is supplied to the cell stack 101 via the air as the thermal medium.

Thus, the heating of the cell stack 101 can be effectively performed by using the heat from the DC/DC converter 110 and the heat from the inverter 21. As a result, the heating of the cell stack 101 can be facilitated, and the energy from the components of the vehicle can be more effectively used.

### Fifth Embodiment

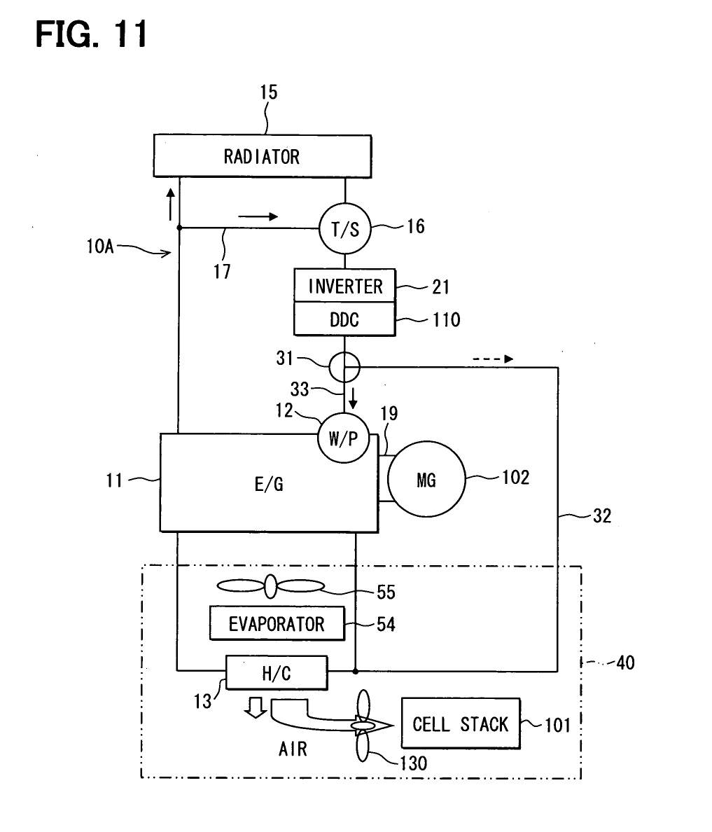

A fifth embodiment of the present invention will be described with reference to FIG. 11. FIG. 11 shows a thermal management system according to the fifth embodiment. In FIG. 11, the parts similar to or corresponding to those of the thermal management system of the first embodiment are indicated by the same reference numbers, and the detail explanation thereof is omitted.

In the thermal management system of the fifth embodiment, as shown in FIG. 11, the second coolant circuit 20 is omitted and the inverter 21 and the motor 102 are located in a single engine coolant circuit 10A, as compared with the thermal management system of the first embodiment. That is, in the thermal management system of the fifth embodiment, by using the single engine coolant circuit 10A in which the coolant for cooling the engine 11 circulates or/and by using the blower member 130, the heating of the respective devices is performed. In the thermal management system of the fifth embodiment, the component of the inverter 21 is made of materials having resistance in the temperature of the coolant circulating in the engine coolant circuit 10A.

As shown in FIG. 11, the thermal management system is provided with a communication passage 19 through which a coolant path inside of the motor 102 communicates with a coolant path inside the engine 11, a passage adjusting device 31 located in the engine coolant circuit 10A, and a bypass passage 32 through which the coolant flowing out of the inverter 21 flows into the heater core 13 while bypassing the engine 11. The passage adjusting device 31 is configured to adjust a ratio of a flow amount of the coolant flowing through the engine 11 or the motor 102 and a flow amount of the coolant flowing through the heater core 13 to be in a range of 0% to 100%. That is, the passage adjusting device 31 can be located to switch a flow of the coolant flowing from the inverter 21 between a circuit passage 33 connected to the engine 11 and the bypass passage 32 connected to the side of the heater core 13. The passage adjusting device 31 may be configured by a flow amount adjusting valve or a switching valve, or the like.

Next, operation and effects of the thermal management system of the fifth embodiment, when heating is required from respective devices, will be described with reference to FIG. 11.

When a heating is required from the cell stack 101, the control device 120 causes the power element 111 of the inverter 21 to be operated in the heat increasing operation. At the heating request state of the cell stack 101, the passage adjusting device 31 is controlled by the control device 120 so that the coolant flowing out of the inverter 21 flows into the bypass passage 32 while bypassing the coolant passage 33, and the thermostat 16 is controlled so that the coolant flowing through the heater core 13 returns to the inverter 21 via the bypass passage 26. Furthermore, the control device 120 controls the blower member 130 so that air having passed through the heater core 13 is blown to the cell stack 101. The control device 120 controls the fan rotation speed of the blower member 130.

Thus, heat generated purposefully from the inverter 21 is transferred to the coolant, and radiated to exterior air in the heater core 13 via the bypass passage 32. Thus, air blown into the heater core 13 by the blower member 130 is heated, and the heated air is sent to the cell stack 101. As a result, the temperature in the respective cell modules of the cell stack 101 is increased by using heat from the inverter 21, and the heating of the cell stack 101 can be performed.

When a heating is required from the engine 11, the control device 120 causes the power element 111 of the inverter 21 to be operated in the heat increasing operation. At the heating request state of the engine 11, the passage adjusting device 31 is controlled by the control device 120 so that the coolant flowing out of the inverter 21 flows through the coolant passage 33 and passes through the engine 11, and the thermostat 16 is controlled by the control device 120 so that the coolant having passed through the heater core 13 returns to the inverter 21 through the bypass passage 17. Thus, heat generated purposefully from the inverter 21 is transferred to the coolant, and is radiated to the engine 11 via the coolant passage 33. Then, the coolant from the engine 11 flows through the heater core 13 and the bypass passage 17 in this order, and returns to the inverter 21. The coolant is continuously circulated in the above coolant cycle, so as to transfer heat from the inverter 21 to the engine 11. As a result, the temperature in the engine 11 is increased, and heating of the engine 11 can be performed.

When a heating is required from the motor 102 for a vehicle traveling, the control device 120 causes the power element 111 of the inverter 21 to be operated in the heat increasing operation. At the heating request state of the motor 102, the passage adjusting device 31 and the thermostat 16 are controlled similarly to the heating of the engine 11, and the motor 102 is controlled to communicate with the engine 11 through the communication passage 19 so that the coolant flows to both the motor 102 and the engine 11. Therefore, heat transmitted by the coolant can be supplied to the motor 102 via the coolant passage 33 and the communication passage 19. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation. At the heating request state of the heater core 13, the passage adjusting device 31 is controlled so that the coolant flowing out of the inverter 21 flows into the heater core 13 via the bypass passage 32, and the thermostat 16 is controlled so that the coolant flowing out of the heater core 13 returns to the inverter 21 through the bypass passage 17. Thus, heat generated purposefully from the inverter 21 is transferred to the coolant, and is radiated to air in the heater core 13 via the bypass passage 32. Then, the coolant flows through the heater core 13 via the bypass passage 32, and returns to the inverter 21 via the bypass passage 17. The coolant is continuously circulated in the above coolant cycle, so as to transfer heat from the inverter 21 to the heater core 13, thereby heating air passing through the heater core 13. As a result, the heat radiation amount from the coolant in the heater core 13 is increased, thereby improving heating capacity in the vehicle compartment.

Next, operation and effects of the thermal management system according to the fifth embodiment will be described. The thermal management system includes the cell stack 101, the motor 102, the engine 11 and the heater core 13, which are used as the devices capable of performing the heating thereof by using the generated heat in the heat increasing operation. Thus, the generated heat in the vehicle can be effectively used for various devices having a heating request.

In the present embodiment, both the electronic member (e.g., inverter 21) that generates heat in the heat increasing operation and the device (e.g., the motor 102, the engine 11 and the heater core 13) that requests a heating are provided in the single engine coolant circuit 10A so as to perform heat exchange with the coolant in the single engine coolant circuit 10A in which the coolant of the engine 11 circulates. Thus, heat generated from the electronic member by the heat increasing operation of the switching power supply device is supplied to at least one of the motor 102, the engine 11 and the heater core 13 with the heating request, by using the coolant as a thermal transmission medium. Accordingly, a thermal supply path is provided through the coolant of the single engine coolant circuit 10A in which the motor 102, the engine 11, the heater core 13 and the electronic member (21, 110) are arranged. Therefore, the thermal management system can perform the heating of the motor 102, the engine 11 and the heater core 13 and the like with a simple structure, by using the coolant circuit of one system.

### Sixth Embodiment

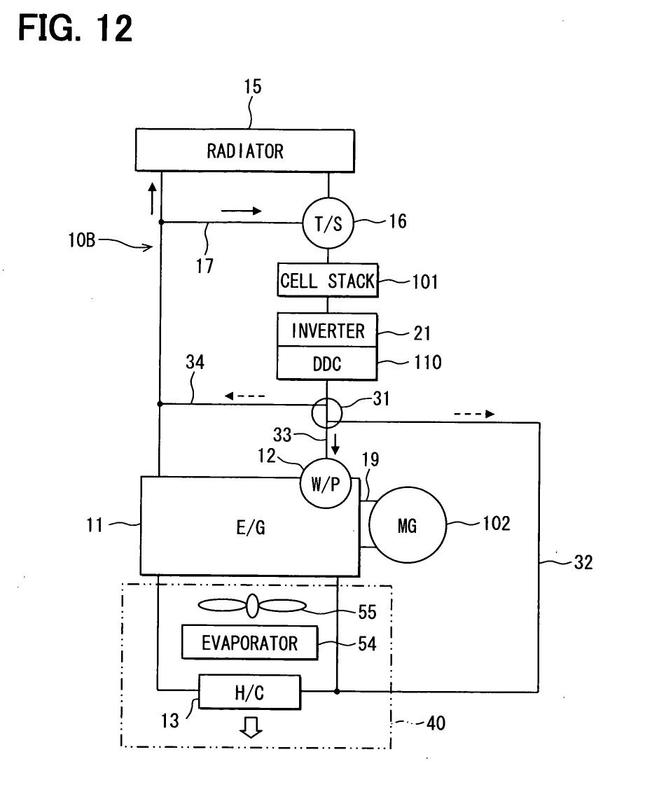

A sixth embodiment of the present invention will be described with reference to FIG. 12. FIG. 12 shows a thermal management system according to the sixth embodiment. In FIG. 12, the parts similar to or corresponding to those of the thermal management system of the fifth embodiment are indicated by the same reference numbers, and the detail explanation thereof is omitted.

In the thermal management system of the sixth embodiment, as shown in FIG. 12, the second coolant circuit 20 described in the first to fourth embodiments is omitted and the inverter 21 and the motor 102 are located in a single engine coolant circuit 10B, similarly to the thermal management system of the fifth embodiment. In the sixth embodiment, the cell stack 101 is also located in the single engine coolant circuit 10B, as compared with the engine coolant circuit 10A of the fifth embodiment. That is, the temperature of the cell stack 101 is adjusted via the coolant in the single engine coolant circuit 10B.

The thermal management system of the present embodiment is provided with the bypass passage 34 through which the coolant flowing out of the inverter 21 flows to the side of the radiator 15 and the side of the cell stack 101 while bypassing the engine 11. The passage adjusting device 31 is configured to adjust a ratio of a flow amount of the coolant flowing through the engine 11 or the motor 102, a flow amount of the coolant flowing through the heater core 13 and a flow amount of the coolant flowing through the radiator 15 or the bypass passage 17 to be in a range of 0% to 100%. That is, the passage adjusting device 31 is located to switch a flow of the coolant flowing from the inverter 21, to any one of the coolant passage 33 through which the coolant flows to the engine 11, the bypass passage 32 through which the coolant flows toward the heater core 13, and the bypass passage 34 through which the coolant flows toward the radiator 15 or the bypass passage 17. The passage adjusting device 31 may be configured by a flow amount adjusting valve or a switching valve, or the like.

Next, operation and effects of the thermal management system according to the fifth embodiment, when heating is required from respective devices, will be described with reference to FIG. 12.

When a heating is required from the cell stack 101, the control device 120 causes the power element 111 of the inverter 21 to be operated in the heat increasing operation. At the heating request state of the cell stack 101, the passage adjusting device 31 is controlled by the control device 120 so that the coolant flowing out of the inverter 21 flows into the bypass passage 34, and the thermostat 16 is controlled so that the coolant flowing through the bypass passage 34 flows into the cell stack 101 through the bypass passage 17. Thus, heat generated purposefully from the inverter 21 is transferred to the coolant, and is radiated to the cell stack 101 via the bypass passage 34 and the bypass passage 17 without being radiated to the radiator 15. Then, the coolant having passed through the cell stack 101 is returned to the inverter 21. As a result, the temperature of the cell stack 101 is increased by using heat from the power element 111 of the inverter 21, and the heating of the cell stack 101 can be performed.

When a heating is required from the engine 11, the control device 120 causes the power element 111 of the inverter 21 to be operated in the heat increasing operation. At the heating request state of the engine 11, the passage adjusting device 31 is controlled by the control device 120 so that the coolant flowing out of the inverter 21 flows through the coolant passage 33 to flow to the engine 11, and the thermostat 16 is controlled by the control device 120 so that the coolant having passed through the heater core 13 returns to the inverter 21 via the bypass passage 17. Thus, heat generated purposefully from the inverter 21 is transferred to the coolant, and is radiated to the engine 11 via the coolant passage 33. Then, the coolant from the engine 11 flows through the heater core 13 and the bypass passage 17 in this order, and returns to the inverter 21. The coolant is continuously circulated in the above coolant cycle, so as to transfer heat from the inverter 21 to the engine 11. As a result, the temperature in the engine 11 is increased, and heating of the engine 11 can be performed.

When a heating is required from the motor 102 for a vehicle traveling, the control device 120 causes the power element 111 of the inverter 21 to be operated in the heat increasing operation. At the heating request state of the motor 102, the passage adjusting device 31 and the thermostat 16 are controlled similarly to the heating of the engine 11, and the motor 102 is controlled to communicate with the engine 11 through the communication passage 19 so that the coolant flows to the motor 102 and the engine 11. Therefore, heat transmitted by the coolant can be supplied to the motor 102 via the coolant passage 33 and the communication passage 19. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation. At the heating request state of the heater core 13, the passage adjusting device 31 is controlled so that the coolant flowing out of the inverter 21 flows into the bypass passage 32 while bypassing the coolant passage 33, and the thermostat 16 is controlled so that the coolant flowing out of the heater core 13 returns to the inverter 21 through the bypass passage 17. Thus, heat generated purposefully from the inverter 21 is transferred to the coolant, and is radiated to air in the heater core 13 via the bypass passage 32. Then, the coolant flows through the heater core 13 via the bypass passage 32, and returns to the inverter 21 via the bypass passage 17. The coolant is continuously circulated in the above coolant cycle, so as to transfer heat from the inverter 21 to the heater core 13, thereby heating air passing through the heater core 13. As a result, the heat radiation amount from the coolant in the heater core 13 is increased, thereby improving heating capacity in the vehicle compartment.

Next, operation and effects of the thermal management system according to the sixth embodiment will be described. The thermal management system includes the cell stack 101, the motor 102, the engine 11 and the heater core 13, which are used as the devices capable of performing the heating thereof by using the generated heat in the heat increasing operation. Furthermore, the cell stack 101 is also located in the single engine coolant circuit 10B in which the heat generated in the inverter 21 is transmitted via the engine coolant. Thus, the engine coolant circuit 10B can be used for heating and cooling the cell stack 101, thereby suitably adjusting the temperature of the cell stack 101.

In the present embodiment, both the electronic member (e.g., inverter 21, DC/DC converter 110) that generates heat in the heat increasing operation and the device (e.g., the motor 102, cell stack 101, the engine 11 and the heater core 13) that requests a heating are provided in the single engine coolant circuit 10B so as to perform heat exchange with the coolant in the same engine coolant circuit 10B in which the coolant circulates. Thus, heat generated from the electronic member by the heat increasing operation is supplied to at least one of the motor 102, the cell stack 101, the engine 11 and the heater core 13, with the heating request, by using the coolant as a thermal transmission medium. Accordingly, a thermal supply path is provided through the coolant of the single engine coolant circuit 10B in which the motor 102, the cell stack 101, the engine 11, the heater core 13 and the electronic member are arranged. Therefore, the thermal management system can perform the heating of at least one of the motor 102, the cell stack 101, the engine 11 and the heater core 13 and the like with a simple structure, by using the coolant circuit of one system.

### Seventh Embodiment

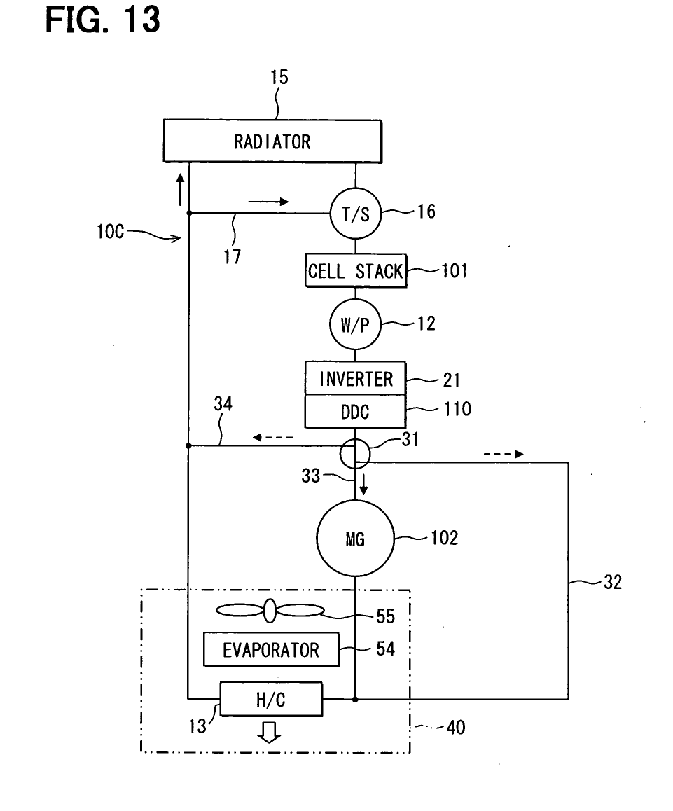

A seventh embodiment of the present invention will be described with reference to FIG. 13. FIG. 13 shows a thermal management system according to the seventh embodiment. In FIG. 13, the parts similar to or corresponding to those of the thermal management system of the fifth or sixth embodiment are indicated by the same reference numbers, and the detail explanation thereof is omitted.

In the thermal management system of the seventh embodiment, as shown in FIG. 13, devices including the cell stack 101, the motor 102 and the heater core 13 are provided in a single fluid circuit (e.g., a single coolant circuit) 10C without having the engine 11, as compared with the thermal management system of the sixth embodiment. The thermal management system of the seventh embodiment can be suitably used for a vehicle without an engine (e.g., internal combustion engine), such as an electrical vehicle and a fuel cell vehicle.

The thermal management system of the present embodiment is provided with the bypass passage 34 through which a fluid such as coolant flowing out of the inverter 21 flows to the side of the radiator 15 and the side of the cell stack 101 while bypassing the motor 102. The passage adjusting device 31 is configured to adjust a ratio of a flow amount of the coolant flowing through the motor 102, a flow amount of the coolant flowing through the heater core 13 and a flow amount of the coolant flowing through the radiator 15 or the bypass passage 17 to be in a range of 0% to 100%. That is, the passage adjusting device 31 can switch a flow of the coolant flowing from the inverter 21, to any one of the coolant passage 33 through which the coolant flows to the motor 102, the bypass passage 32 through which the coolant flows toward the heater core 13, and the bypass passage 34 through which the coolant flows toward the radiator 15 or the bypass passage while bypassing the motor 102 and the heater core 13.

Next, operation and effects of the thermal management system according to the seventh embodiment, when heating is required from respective devices, will be described with reference to FIG. 13.

When a heating is required from the cell stack 101, the control device 120 causes the power element 111 of the inverter 21 to be operated in the heat increasing operation. At the heating request state of the cell stack 101, the passage adjusting device 31 is controlled by the control device 120 so that the coolant flowing out of the inverter 21 flows into the bypass passage 34, and the thermostat 16 is controlled so that the coolant flowing through the bypass passage 34 flows into the cell stack 101 through the bypass passage 17. Thus, heat generated purposefully from the inverter 21 is transferred to the coolant, and is radiated to the cell stack 101 via the bypass passage 34 and the bypass passage 17 without being radiated to the radiator 15. Then, the coolant having passed through the cell stack 101 is returned to the inverter 21. As a result, the temperature of the cell stack 101 is increased by using heat from the power element 111 of the inverter 21, and the heating of the cell stack 101 can be performed.

When a heating is required from the motor 102, the control device 120 causes the power element 111 of the inverter 21 to be operated in the heat increasing operation. At the heating request state of the motor 102, the passage adjusting device 31 is controlled by the control device 120 so that the coolant flowing out of the inverter 21 flows through the coolant passage 33 to flow to the motor 102, and the thermostat 16 is controlled by the control device 120 so that the coolant having passed through the heater core 13 returns to the inverter 21 through the bypass passage 17, in the single coolant circuit 10C. Thus, heat generated purposefully from the inverter 21 is transferred to the coolant, and is radiated firstly to the motor 102 via the coolant passage 33. Then, the coolant from the motor 102 flows through the heater core 13 and the bypass passage 17 in this order, and returns to the inverter 21, without passing through the radiator 15. The coolant is continuously circulated in the above coolant cycle, so as to transfer heat from the inverter 21 to the motor 102. As a result, the temperature in the motor 102 is increased, and heating of the motor 102 can be performed.

When a heating is required from the heater core 13 such as in a case where heating capacity for heating the vehicle compartment is insufficient, the control device 120 causes the power element 111 of the inverter 21 to be operated in the heat increasing operation. At the heating request state of the heater core 13, the passage adjusting device 31 is controlled so that the coolant flowing out of the inverter 21 flows into the heater core via the bypass passage 32 while bypassing the coolant passage 33, and the thermostat 16 is controlled so that the coolant flowing out of the heater core 13 returns to the inverter 21 through the bypass passage 17. Thus, heat generated purposefully from the inverter 21 is transferred to the coolant, and is radiated to air in the heater core 13 via the bypass passage 32. Then, the coolant flows through the heater core 13 via the bypass passage 32, and returns to the inverter 21 via the bypass passage 17 without passing through the radiator 15. The coolant is continuously circulated in the above coolant cycle, so as to transfer heat from the inverter 21 to the heater core 13, thereby heating air passing through the heater core 13. As a result, the heat radiation amount from the coolant in the heater core 13 is increased, thereby improving heating capacity in the vehicle compartment.

In the thermal management system, during the heating of the motor 102 or the heater core 13, the coolant having passed through the motor 102 or/and the heater core 13 may flow through the radiator 15 so as to adjust the temperature of the coolant flowing through the cell stack 101.

Next, operation and effects of the thermal management system according to the seventh embodiment will be described. The thermal management system includes the cell stack 101, the motor 102 and the heater core 13, which are used as the devices capable of performing the heating thereof by using the generated heat in the heat increasing operation of the electronic member such as the inverter 21. Furthermore, the cell stack 101 is located in the single coolant circuit 10C in which the motor 102 for a vehicle traveling is provided. Thus, the coolant circuit 10C can be used for heating and cooling the cell stack 101 and the motor 102, thereby suitably adjusting the temperature of the cell stack 101 and the motor 102 in the single coolant circuit 10C. Furthermore, the heater core 13 is located in the coolant circuit 10C, thereby heating air by using the coolant from the inverter 21 as a heat source.

In the present embodiment, both the electronic member (e.g., inverter 21, DC/DC converter 110) that generates heat in the heat increasing operation and the device (e.g., the motor 102, cell stack 101 and the heater core 13) that requests a heating are provided in the single coolant circuit 10C so as to perform heat exchange with the coolant in the same coolant circuit 10C in which the coolant of the motor 102 circulates. Thus, heat generated from the electronic member by the heat increasing operation is supplied to at least one of the motor 102, the cell stack 101 and the heater core 13, having the heating request, by using the coolant as a thermal transmission medium. Accordingly, a thermal supply path is provided through the coolant of the single coolant circuit in which the motor 102, the cell stack 101, the heater core 13 and the electronic member are arranged. Therefore, the thermal management system can perform the heating of at least one of the motor 102, the cell stack 101 and the heater core 13 and the like with a simple structure, by using the coolant circuit (fluid circuit) of one system.

### Eighth Embodiment

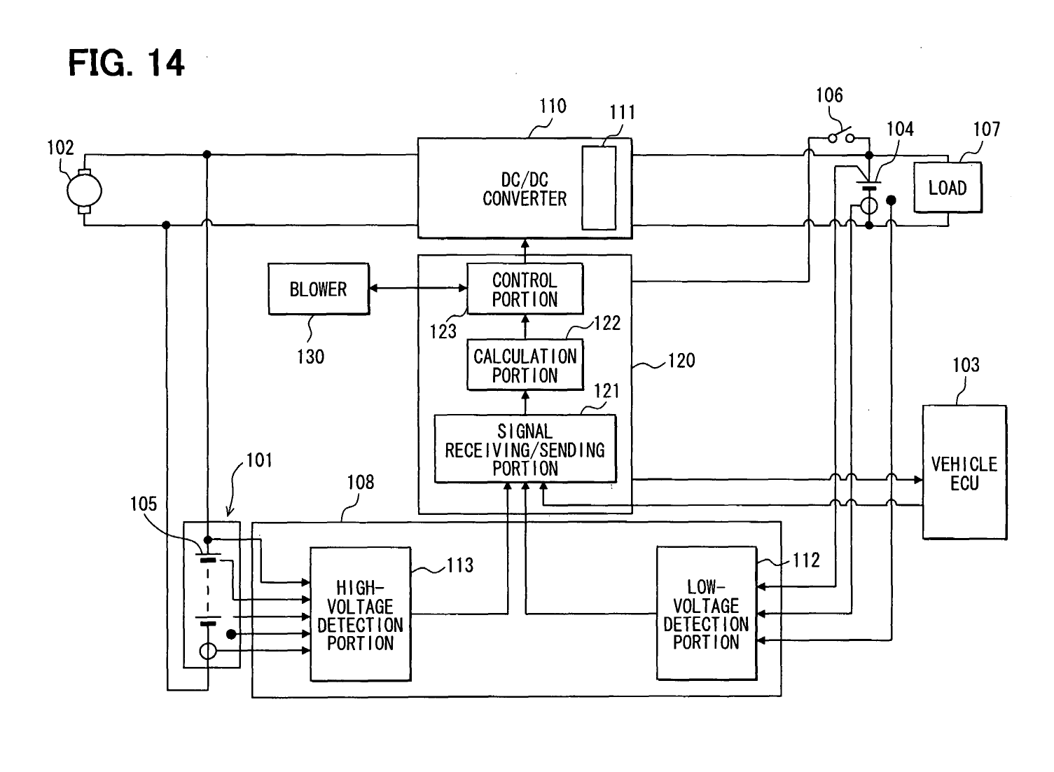

An eighth embodiment of the present invention will be described with reference to FIGS. 14 to 19.

In a cell heating device that is an example of a thermal management system of the eighth embodiment, heat generated from an electronic member in an inefficient control operation is transmitted to a battery via air, thereby heating the battery. The inefficient control operation is an heat increasing operation of a switching power supply device, in which heat generated from an electronic member is increased as compared with a generation operation state of the switching power supply device.

The cell heating device of the present embodiment can be suitably used for a hybrid vehicle, an electrical vehicle and a fuel cell vehicle. For example, in the hybrid vehicle, an internal combustion engine and a motor driven by an electrical power charged in a battery are combined to be used as a vehicle driving source. In the electrical vehicle, a motor driven by electrical power charged in a battery is used as a vehicle driving source. In the fuel cell vehicle, a fuel cell and a secondary battery are combined to be used as a vehicle driving source. The cell heating device performs a heating of a battery or the like when a predetermined condition is satisfied. The battery may be a nickel-hydrogen secondary battery, a lithium-ion secondary battery, an organic radical battery or the like. The battery is accommodated in a box, and the box having therein the battery can be arranged under a vehicle seat, a space between a rear seat and a trunk room or a space between a driver's seat and a front-passenger's seat next to the driver's seat.

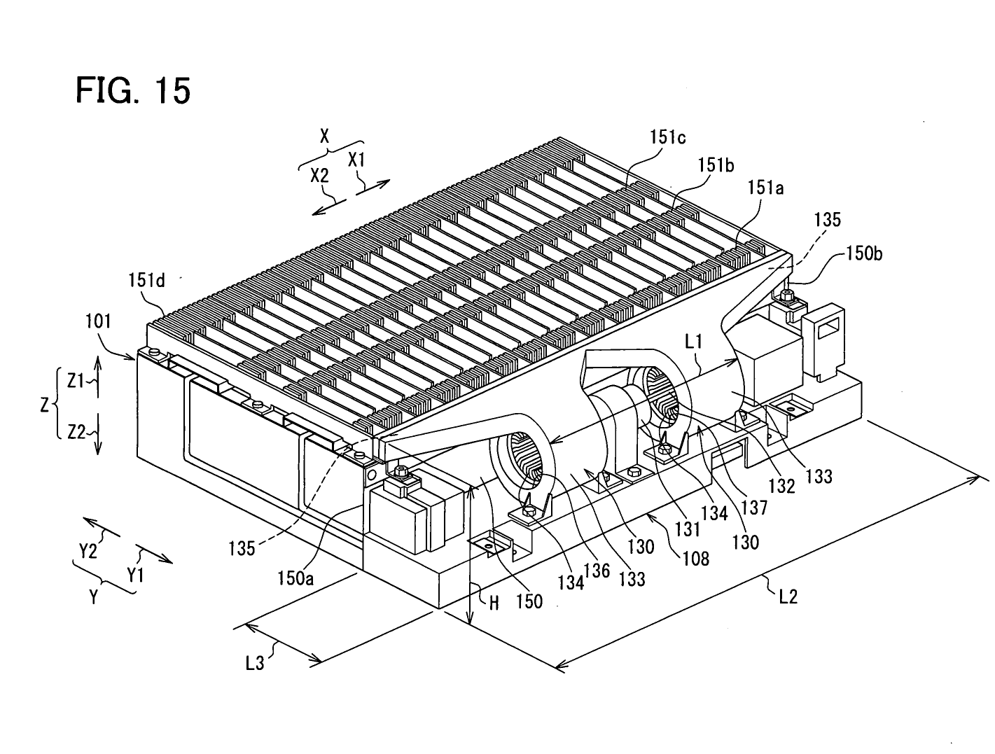

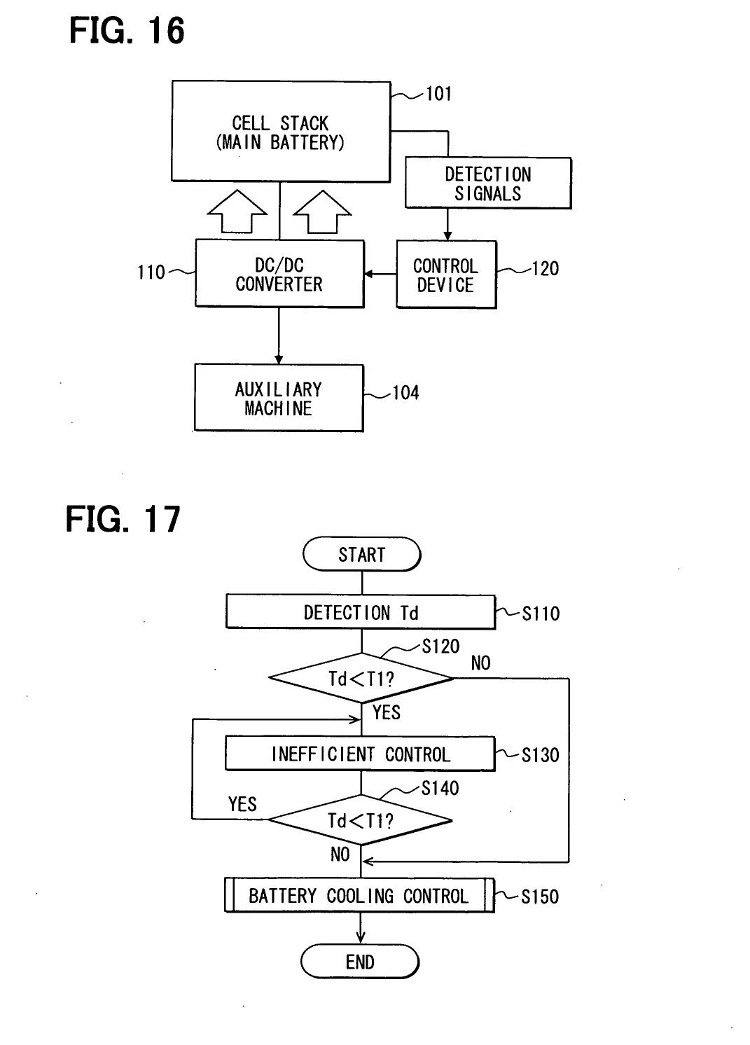

FIG. 14 is a block diagram showing the cell heating device used as a thermal management system according to the eighth embodiment, FIG. 15 is a schematic diagram showing an integrated structure of a cell stack 101, blower members 130 and electronic members according to the eighth embodiment, and FIG. 16 is a schematic diagram showing a thermal transmission in a heating of the cell heating device according to the eighth embodiment. In FIG. 15, Y indicates a longitudinal direction of each cell module 105 extending as in a thin plate, and the longitudinal direction Y corresponds to an air blowing direction in the cell stack 101. X indicates a stack direction perpendicular to the longitudinal direction of the cell modules 105, in which a plurality of cell modules 105 are stacked, and Z indicates a top-bottom direction (height direction) of the cell stack 101, which is perpendicular to both the longitudinal direction Y and the stack direction X.

As shown in FIGS. 14 and 15, the cell heating device includes a cell stack 101 that is a stack assembly of the plural cell modules 105, and an electronic member used for charge or discharge of the cell modules 105 and for a temperature adjustment of the cell modules 105. The cell heating device is integrated with blower members 130 for blowing air to the cell stack 101, and the integrated structure is mounted to a vehicle as a cell assembly in the stack direction X. The plural cell modules 105 are electrically connected in series, and the side surfaces of the cell modules 105 are arranged adjacent to each other. The plural cell modules 105 are integrally constructed and are accommodated in the box. The electronic member may include the DC/DC converter 110, a motor 131 for driving the blower members 130, components controlled by an inverter, and various electronic control units. For example, the electronic member is an electronic member adjusted by a power element that is an example of the switching power supply device. The operation of the power element is controlled by the control device 120.

The box for accommodating the cell stack 101 is a rectangular parallelepiped box made of a resin or a metal. One side surface of the box is detachably configured in order to perform maintenance of the cell stack 101. The box is provided with an attachment portion for fixing the box to the vehicle by using bolts, and a device receiving portion for receiving therein devices.

The device receiving portion has therein a cell monitoring device 108, a control device 120 and wire harness for electrically connecting various devices. Detection signals from various sensors are input to the cell monitoring device 108, thereby monitoring a cell state such as voltage and current in the cell modules 105. The control device 120 is configured to be capable of communicating with the cell monitoring device 108, to control an electrical power as well as an electrical power conversion of the DC/DC converter 110, and to control the drive of the motor 131 of the blower members 130. The cell monitoring device 108 is a battery electronic control unit (battery ECU) connected to the cell stack 101 and various wires, and monitors and controls the cell state of the various cell modules 105 of the cell stack 101.

As shown in FIG. 14, the cell monitoring device 108 includes a high-voltage detection portion 113 and a low-voltage detection portion 112. Various information of the cell stack 101 that is a main battery (i.e., high-voltage battery), such as temperature information, current information, voltage information, inner resistance information, environmental temperature information and the like of the cell stack 101 are input to the high-voltage detection portion 113. Various information of the auxiliary battery 104 that is an auxiliary battery (i.e., low-voltage battery) in the present embodiment, such as temperature information, current information, voltage information, inner resistance information, environmental temperature information and the like of the auxiliary battery 104 are input to the low-voltage detection portion 112.

The control device 120 includes a signal receiving/sending portion 121, a calculation portion 122, and a control portion 123, as shown in FIG. 14. The signal receiving/sending portion 121 receives signals output from the high-voltage detection portion 113, the low-voltage detection portion 112 and the vehicle ECU 103. The calculation portion 122 calculates a cell state based on information of the various signals outputted from the signal receiving/sending portion 121. Then, the control portion 123 controls the electrical power and the electrical power conversion based on the calculated value in the calculation portion 122. The control device 120 controls operation of the power element (e.g., switching power supply device), so as to control the motor 131 of the blower, members 130. Electrical power of the auxiliary battery 104 is supplied to the control device 120 when an ignition switch 106 is turned on.

In the example of FIG. 15, two blower members 130 are provided to have respectively centrifugal fans 134. The control device 120 detects the rotation speeds of the fans 134 of the blower members 130, and detects the temperature of air to be drawn into the fans 134 of the blower members 130. The control device 120 controls the rotation speed of each fan 134 based on an air temperature to be drawn into the fan 134 and a cell temperature output from the high-voltage detection portion 113, in accordance with a pre-stored control program, such that the cell temperature of the cell stack 101 becomes in a suitable temperature range. The control portion 123 of the control device 120 performs a PWM control by changing the duty ratio of a pulse wave of electrical voltage, and adjusts the rotation speed of the motor 131 by the PWM control in accordance with a cooling capacity, so as to control the temperature of the cell stack 101. The control device 120 can perform communication with various control devices (e.g., vehicle ECU 103) by the signal receiving/sending portion 121 via communication lines connected to a communication connector.

The DC/DC converter 110 is a device used for controlling charge and discharge of the cell modules 105. The DC/DC converter 110 is an electronic member provided between a high-voltage power supply system and a low-voltage power supply system. Here, the high-voltage power supply system includes the cell stack 101 (i.e., high voltage battery, main battery) that is connected to a high load such as the motor 102 used for power generation and for traveling of a hybrid vehicle. The low-voltage power supply system includes the auxiliary battery 104 (auxiliary machine) that supplies electrical power to a low load 107. The electrical power conversion of the DC/DC converter 110 applied to the high load of the motor 102 or the like, and the electrical power conversion of the DC/DC converter 110 to the low load 107 are adjusted by the power element 111.

The power element 111 is an example of a switching power supply device made of a transistor and a diode, and is capable of turning on or off a part of the electrical circuit for converting and adjusting electrical power. The control device 120 changes at least one of the drive frequency and the duty ratio (i.e., on/off time ratio of input voltage) input to the power element 111, thereby changing the level of the output voltage. When electrical power is output from the cell stack 101 of a high voltage (e.g., 300V) to the auxiliary battery 104 of a low voltage (e.g., 3V) in a general operation, the operation of the power element 111 is controlled so that an efficiency of the power element 111 becomes about 90%.

In contrast, in an inefficient control operation, the control device 120 increases at least one of the drive frequency and the duty ratio to be inputted to the power element 111, and controls the power element 111 so that an efficiency of the power element 111 is decreased as compared with the general operation state. For example, in the inefficient control operation of the power element 111, the efficient of the power element 111 is controlled to become about 20%. In the inefficient control operation of the power element 111, the power element 111 generates heat and heat is also radiated from the DC/DC converter 110, thereby heating the cell modules 105. FIG. 16 is a schematic diagram showing a thermal movement during the heating of the cell heating device. The control device 120 performs the inefficient control operation when a low-temperature state of the cell modules 105 of the cell stack 101 is detected.

The inefficient control operation can be performed by the control device 120, similarly to the description of the first embodiment shown in FIGS. 3 to 6, for example.

The control device 120 determines the low-temperature state of the cell modules 105 by using at least one of various information including cell information, environmental information of the cell modules 105 and system information. For example, the cell information includes the temperature, the voltage value, the current value and inner resistance of the cell modules 105. The environmental information of the cell modules 105 includes the environmental temperature (e.g., outside temperature) of the cell stack 101, for example. Furthermore, the system information includes the temperature and the operation state of various control units configuring the cell heating device. The temperature state of the cell modules 105 may be directly detected, or may be calculated by the control device 120 by using various information having the relation with the temperature of the cell modules 105. The temperature state of the cell modules 105 can be detected by using a generally known method or device.

Next, an electrical unit (electrical parts, wire harness unit) relative to the cell stack 101 will be described. The electrical unit includes various sensors configured to detect a cell state of the respective cell modules 105, and wire harness for sending signals detected by the various sensors to the cell monitoring device 108. The sensors for monitoring the cell state can be located respectively to the cell modules 105, and the wires are drawn from upper surfaces of the respective cell modules 105. Because the wires are drawn respectively from the cell modules 105, the electrical unit is configured to draw the respective wires of the cell modules 105 on a side X2 in the stack direction X. The cell stack 101 is provided with a negative terminal and a positive terminal that are respectively provided at positions near ends 150a, 150b of one side surface 150 of the cell stack 101. As shown in FIG. 15, the one side surface 150 of the cell stack 101 is a surface of the box on a side Y1 in the longitudinal direction Y.

A relay device (e.g., system main relay SMR) for controlling an electrical power supply from the cell stack 101 to the motor 102 is connected to the negative terminal and the positive terminal of the cell stack 101. The relay device is controlled by the control device 120 so as to control supply and stop of electrical current applied to the cell stack 101.

A service plug (not shown) is provided between the positive terminal of the cell stack 101 and the relay device, and is configured detachably. When the service plug is detached during maintenance, a main current path of the cell stack 101 is turned off. An electrical current sensor (not shown) is located between the relay device connected to the negative terminal, to detect a current value of the cell stack 101. Electrical current signal detected by the electrical current sensor is output to the high-voltage detection portion 113 of the cell monitoring device 108, as a charge current or a discharge current. The negative terminal and the positive terminal of the cell stack 101 is connected to a high-load device such as the motor 102 via the relay device.

Next, the cell modules 105 for configuring the cell stack 101 will be described. Each of the cell modules 105 is a flat rectangular parallelepiped member having an outer peripheral surface covered by a shell case made of an electrical insulation resin. Each cell module 105 is provided with a positive terminal portion and a negative terminal portion located separately at two longitudinal end sides, and both the positive terminal portion and the negative terminal portion are exposed from the shell case. In the example of FIG. 15, a pair of cell modules 105 extending in the longitudinal direction Y are arranged in the longitudinal direction Y within the box, and is spaced from each other by a predetermined distance in the longitudinal direction Y. A plurality of pairs of the cell modules 105 arranged in the longitudinal direction Y are stacked adjacent to each other in the stack direction X within the length L2 of the box.

For example, the cell modules 105 totally arranged in the box are started from the negative terminal portion of a first cell module on the side of the longitudinal end portion 150a of the one surface 150 of the cell stack 101, and are extended to the positive terminal portion of a seventh cell module on the side of the longitudinal end portion 150b of the one surface 150 of the cell stack 101, and second to sixth cell modules are located between the first and seventh cell modules in the stack direction X such that the respective positive and negative terminal portions of the second to sixth cell modulates are electrically connected in the longitudinal direction Y in series. The negative terminal portion of the first cell module is connected to the negative terminal of the cell stack 101, and the positive terminal portion of the seventh cell module is connected to the positive terminal of the cell stack 101.

Thus, an electrode portion capable of being connected electrically to the negative terminal portion of the first cell module corresponds to the negative electrode portion of the cell stack 101, and an electrode portion capable of being connected electrically to the positive terminal portion of the seventh cell module corresponds to the positive electrode portion of the cell stack 101. The positive terminal portion of the first cell module on the side Y2 of the first cell module is electrically connected to the negative terminal portion, on the side Y1 of the second cell module by an electrode portion extending in the longitudinal direction Y. Furthermore, the positive terminal portion of the second cell module on the side Y2 of the second cell module is electrically connected to the negative terminal portion on the side Y1 of the third cell module by an electrode portion extending in the longitudinal direction Y. Similarly, the positive terminal portion of the third cell module on the side Y2 of the third cell module is electrically connected to the negative terminal portion on the side Y1 of the fourth cell module by an electrode portion extending in the longitudinal direction Y, the positive terminal portion of the fourth cell module on the side Y2 of the fourth cell module is electrically connected to the negative terminal portion on the side Y1 of the fifth cell module by an electrode portion extending in the longitudinal direction Y.

The fifth to seventh cell modules are electrically connected similarly to the above. The positive terminal portion and the negative terminal portion of adjacent cell modules are electrically connected in series by using the respective electrode portion extending in the longitudinal direction Y between adjacent cell modules to be minderingly electrically connected from the first cell module to the seventh cell module in series. The negative terminal portion of the seventh cell module is electrically connected to the positive terminal portion of the sixth cell module on the side Y2 by using the electrode portion. Accordingly, all the cell modules 105 from the electrode portion on the side Y1 of the longitudinal direction Y of the first cell module to the electrode portion on the side Y2 in the longitudinal direction Y of the seventh cell module are electrically connected in series via plural electrode portions such that electrical current flows meanderingly in the cell modules 105.

Cooling fins 151a, 151b, 151c and 151d are respectively located on the electrode portions so as to transmit heat from the cell modules 105 to the cooling fins 151a-151d. In the example of FIG. 15, the cooling fins 151a-151d are respectively located on respective terminal portions on the top side Z1, Each of the cooling fins 151a-151d is a corrugated fin made of an aluminum alley, and the wave shape of the cooling fin 151a-151d extends in the stack direction X. The cooling fins 151a-151d are configured such that air passes through between the convex and valley portions of the cooling fins 151a-151d in the longitudinal direction Y.

Next, the blower members 130 will be described. In the present embodiment, the two blower members 130 are provided adjacently on the side surface 150 that is a surface approximately perpendicular to the longitudinal direction Y of each cell module 105. The blower members 130 are integrally provided on the side surface 150 such that an air passage 135 of each of the two blower members 130 is enlarged in the stack direction X of the cell stack 101, as toward air outlets of the blower members 130, as shown in FIG. 15. Therefore, air is blown from the blower members 130 to the cell stack 101 in the direction Y in the entire length L2 of the cell stack 101. In the example of FIG. 15, the two blower members 130 include two sirocco fans 134, a motor 131 for driving and rotating the two sirocco fans 134, and two casings 133 that respectively receive the sirocco fans 134. The sirocco fan 134 is one example of a centrifugal fan. The casings 133 of the blower members 130 are provided respectively with air suction ports 136, 137 opened approximately in the stack direction X, and the air passages 135 that expand to the air outlets of the blower members 130 from the air suction ports 136, 137, respectively.

The two sirocco fans 134 are respectively fixed to two axial end sides of a rotation axis 132 of the motor 131. The rotation axis 132 can be set within the height dimension H of the cell stack 101 in the top-bottom direction Z. Each of the two casings 133 is a scroll casing configured to accommodate the sirocco fan 134 and having therein a scroll portion. The casings 133 have air suction ports 136, 137 opened at two sides in the axial direction. Attachment legs are integrally formed with each of the casings 133 by using fastening members such as bolts, so that the casings 133 is attached to a vehicle member or the device receiving portion.

The casing 133 is provided with the air outlet from which air drawn from the air suction port 136, 137 is blown toward the upper portion of the cell stack 101, including the top surface of the cell stack 101. The air passage 135 expands from a passage between the forward blades of the sirocco fan and the inner wall surface of the casing 133, to the air outlet. In the example of FIG. 15, the air passage 135 expanding in the stack direction X as toward the air outlet is arranged on an upper side of the sirocco fan 134 such that the air outlet of the blower member 130 opens toward the upper portion of the cell stack 101. The length of the air outlets of the two blower members 130 in the stack direction X is approximately equal to the length dimension L2 of the cell stack 101 in the stack direction X.

Because the air passage 135 expands in the stack direction X as toward the air outlet, air can be uniformly blown to the all length L2 of the cell stack 101 in the stack direction X. Because of the above arrangement of the blower members 130, the dimension of the casing 133 in the longitudinal direction Y can be made smaller.

The air outlet of each blower members 130 is provided as a single flat rectangular opening that is open toward the upper portion of the cell stack 101, and the height dimension of the rectangular opening in the top-bottom direction Z is greatly shorter than the lateral dimension of the rectangular opening in the stack direction X. The two air outlets arranged in the axial direction of the rotation axis 132 (i.e., the stack direction X) are continuously opened in the blower members 130 so as to have an entire opening length in the stack direction X, approximately equal to the length L2 of the cell stack 101 in the stack direction X. The air outlet of the blower member 130 is provided at a position higher than the sirocco fan 134 in the top-bottom direction Z, at a position closer to the cell stack 101 more than the sirocco fan 134. That is, the casing 133 is formed into a shape expanding from an upper side of the sirocco fan 134 to the side of the cell stack 101.

Because air (e.g., cool air) is blown from the air outlet of the blower member 130 toward the upper portion of the cell stack 101, air can flow through the upper portion of the cell stack 101 toward downstream in the longitudinal direction Y. Therefore, air absorbs heat while passing through the cooling fins 151a-151d, and is discharged from an air discharge port of the cell stack 101. The air discharge port of the cell stack 101 is provided in a side surface of the box on the side Y2 in the longitudinal direction Y at an upper side portion of the box (i.e., Z1 side portion). For example, the air discharge port is provided in the side surface of the cell stack 101, opposite to the air outlet of the blower member 130 and extends approximately in the entire length L2 of the cell stack 101. The air discharge port is located at a height position similar to the height position of the air outlet of the blower member 130 and the cooling fins 151a-151d.

The cool air blown from the air outlets of the blower members 130 flows through the upper portion of the cell stack 101 with a small flow amount having relatively a high speed and a high static pressure. Therefore, noise caused due to airflow in small passages within the casing 133 and the box of the cell stack 101 can be reduced. Air drawn from the air suction port 136, 137 is blown from the air outlets of the casings 133 after passing through the expanding air passages 135. Because the height position of the air outlets of the blower members 130 is located at the upper side portion of the cell stack 101 in the box, and the air outlets of the blower members 130 extend approximately in the entire length L2 of the cell stack 101, the air blown by the blower members 130 can be sent to the entire area at the upper side portion of the cell stack 101.

In each of the casings 133 located at two axial end sides of the motor 131, an expending degree of the casing 133 expanding toward outside of the cell stack 101 in the stack direction X is made larger than an expanding degree of the casing 133 expanding toward a center portion in the length L2 of the stack direction X. That is, the sirocco fan 134 is shifted toward the side of the motor 131 from a center of each casing 133 in the stack direction X, in each blower member 130. Accordingly, the scroll portion of each casing 133 is shifted toward the motor 131 from the center of each blower member 130 in the stack direction X, and thereby the center of gravity of each blower member 130 is offset toward the motor side (center side). As shown in FIG. 15, the axial length L1 of the scroll portions of the casings 133 is made shorter than the length L2 of the cell stack 101 in the stack direction X. Therefore, a large space can be formed on the sides of the scroll portions of the casings 133 in the stack direction X, to expend widely to the two longitudinal end portions 150a, 150b of the one side surface 150 of the cell stack 101.

An electronic member may be located in a space on one side of the scroll portion of the casing 133 inside the longitudinal end portions 150a and 150b of the one side surface 150. Alternatively, the electronic member may be located in a space on one side of the suction port 136 or 137 of the casing 133 inside the longitudinal end portions 150a and 150b of the one side surface 150. The electronic member may be located at a position of the space of a rectangular parallelepiped shape that is defined by the height dimension H of the cell stack 101 in the top-bottom direction Z, the length dimension L2 of the cell stack 101 in the stack direction X, and the dimension L3 of the blower members 130 in the longitudinal direction Y (i.e., air flow direction) of the cell modules 105, as shown in FIG. 15. That is, the electronic member is located by effectively using the space other than the mounting space of the blower members 130, among the rectangular parallelepiped space defined by the dimensions H, L2 and L3. Accordingly, the electronic member can be mounted without increasing the entire dimension of the cell heating device, thereby improving the mounting performance of the cell heating device to a vehicle.

Operation of the cell heating device will be described with reference to FIGS. 16 and 17. FIG. 16 is a schematic diagram showing the cell heating device of the eighth embodiment, and FIG. 17 is a flow diagram showing a cell temperature control performed by the control device 120 in the cell heating device according to the eighth embodiment.

When electrical current is supplied to the control device 120, the control device 120 reads information regarding a cell temperature Td of the cell modules 105, at step S110. That is, at step S110, the cell temperature Td is input to the control device 120. Next, at step S120, it is determined whether the detected cell temperature Td is lower than a predetermined temperature T1. When the detected cell temperature Td is lower than the predetermined temperature T1, the control device 120 determines that the cell modules 105 are at a low temperature state and are not effectively operated. Thus, when the detected cell temperature Td is lower than the predetermined temperature T1, the control device 120 determines that a heating of the cell stack 101 is necessary.

When the cell temperature Td is not lower than the predetermined temperature T1 at step S120, it is unnecessary to perform the heating of the cell stack 101, and a general operation (e.g., battery cooling control) of the cell modules 105 is performed at step S150 such that the cell modules 105 are controlled in a predetermined temperature range. Thus, the cell modules 105 can be efficiently operated at step S150. For example, at step S150, the battery cooling control is performed so that the temperature Td of the cell modules 105 is in a suitable temperature range. In the battery cooling control, air is blown by the blower members 130 toward the upper portion of the cell stack 101 so that the cell temperature Td is controlled in the suitable temperature range in which the cell modules 105 can be effectively operated. After performing step S150, the control program of the control device 120 returns to step S110.

When it is determined that the cell temperature Td is lower than the predetermined temperature T1 at step S120, the control device 120 determines that a heating of the cell modules 105 is necessary, and an inefficient control operation of the power element 111 (switching power supply device) for adjusting an output electrical power of an electronic member is performed at step S130. For example, in the inefficient control operation of the power element 111, the drive frequency or the duty ratio applied to the power element 111 may be increased or a rising time of the switching in the control signal input to the power element 111 may be increased, as compared with the general operation state, as described in any one of the above embodiments. Accordingly, in the inefficient control operation of the switching power supply device, the number of the transient states with the variation of the current and the voltage or/and the entire time of the transient states with the variation of the current and the voltage can be made larger than that in the general operation state, similarly to the examples of the first embodiment. Thus, the heat generating time or/and the average heat generating amount of the electronic member can be increased as compared with the general operation state, thereby increasing heat radiation amount to the exterior and also increasing the heat amount transmitted to the cell stack 101. Accordingly, the heating of the cell modules 105 is performed thereby increasing the cell temperature.

The inefficient control operation of step S130 is continuously performed until the control device 120 determines that the cell temperature Td is not lower than the predetermined temperature T1 at step S140. When the control device 120 determines that the cell temperature Td is not lower than the predetermined temperature T1 at step S140, the heating of the cell modules 105 is ended, and the general control operation (e.g., battery cooling control) is performed at step S150.

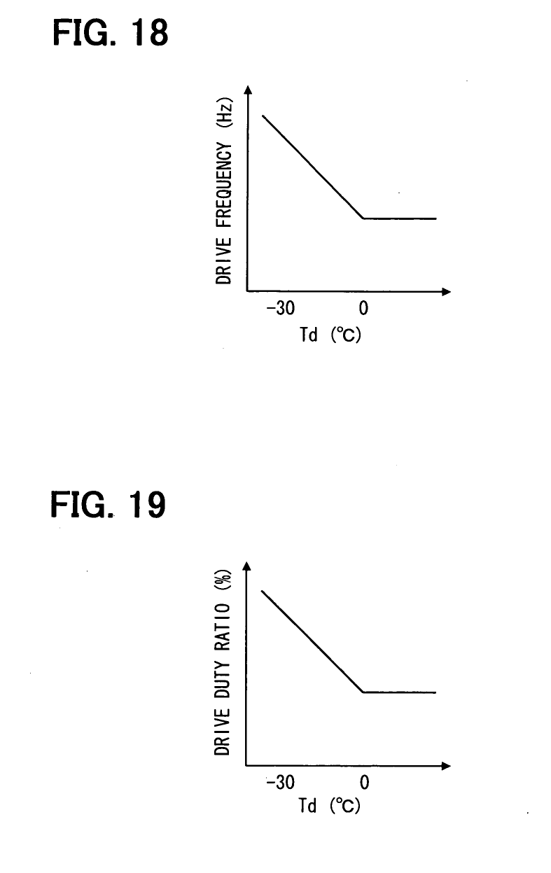

FIG. 18 is a map showing the relationship between the drive frequency input to the power element 111 (switching power supply device) and the cell temperature Td, during the heating of the cell modules 105, according to the eighth embodiment, and FIG. 19 is a map showing the relationship between the drive duty ratio input to the power element 111 (switching power supply device) and the cell temperature Td, during the heating of the cell modules 105, according to the eighth embodiment. As shown in FIGS. 18 and 19, an increase amount of at least one of the drive frequency and the duty ratio to be inputted to the power element 111 may be changed in accordance with decrease of the temperature of the cell modules 105. In the example of FIGS. 18 and 19, the drive frequency (Hz) and the duty ratio (%) are controlled to be increased as the cell temperature Td decreases, when the cell temperature Td is lower than a predetermined temperature (e.g., 0° C.). In contrast, when the cell temperature Td is not lower than the predetermined temperature (e.g., 0° C.), the drive frequency (Hz) and the duty ratio (%) are set respectively at constant values.

According to the present embodiment, at least one of the drive frequency (Hz) and the duty ratio (%) is controlled to be increased as the cell temperature Td decreases, when the cell temperature Td is in a low temperature range lower than the predetermined temperature (e.g., 0° C.). Thus, even in the low temperature range, the heating of the cell modules 105 can be facilitated, thereby improving the efficiency of the cell modules 105.

Next, operation and effects of the cell heating device according to the present embodiment will be described. The cell heating device can perform the heating of the cell stack 101 when a predetermined condition is satisfied. The cell modules 105 are electrically connected integrally so as to form the cell stack 101. The cell heating device is used for charge and discharge of the plural cell modules 105, and is also used for the temperature adjustment of the plural cell modules 105. As shown in FIG. 16, the cell heating device includes the DC/DC converter 110 operated by electrical power adjusted by the power element 111, and control device 120 configured to control the power element 111 so as to control the DC/DC converter 110. When the control device 120 determines that the cell modules 105 is at a low temperature state, the number of the transient states with the variation of the current and the voltage or/and the entire time of the transient states with the variation of the current and the voltage can be made larger than that at the general operation state, thereby performing the inefficient control operation and performing the heating of the cell modules 105 by using the generated heat in the inefficient control operation.

According to the present embodiment, the control device 120 performs the inefficient control operation as the heat increasing operation, in which the number of the transient states where the current and the voltage increase or decrease or/and the time of the transient state are set to be larger than the general operation state. In the inefficient control operation, the power element 111 (switching power supply device) is operated such that the number of the transient states or/and the time of the transient states are set to be larger than the general operation state, so as to increase switching loss and conductive loss of the electronic member than that of the general operation state. Thus, heat generated from the electronic member can be increased. By controlling the operation of the existing electronic member, the heating due to the thermal management system can be accurately increased, and the heating can be facilitated. The switching loss is a loss generated while a built-in transistor is transient from on to off or is transient from off to on, and the conductive loss is a loss after the transistor is completely turned on. Accordingly, the heating of the cell modules 105 can be effectively performed by effectively using the devices generally mounted to the vehicle. Thus, the cell heating device can perform the heating of the cell modules 105 at a low cost, without increasing the outer dimension of the cell stack 101.

The electronic member operated inefficiently during the heating of the cell modules 105 may be the DC/DC converter 110 that, is configured to perform electrical power conversion between a high-voltage electrical power system and a low-voltage electrical power system. For example, the high-voltage electrical power system is electrically connected to a high-voltage load including the cell stack 101 to be capable of performing electrical power conversion, and the low-voltage electrical power system is electrically connected to a low-voltage load to supply electrical power to the low-voltage load.

Thus, the heating of the cell modules 105 can be performed without adding a special heating machine, by effectively using the DC/DC converter 110.

As shown in FIG. 15, the casings 133 are provided with the air passage 135 expanding in its width in the stack direction X as toward the air outlets of the blower members 130. That is, the width of the air passage 135 of the casing 133 is reduced from the air outlet to the side of the air suction port 136, 137 in the stack direction X, a large space can be formed on the sides of the scroll portions of the casings 133. Thus, a mounting space of the blower member 130 is reduced on the one side surface 150, thereby forming dead spaces adjacent to the one side surface 150 at one side of the scroll portion of the casing 133.

Thus, an electronic member may be located in the space on one side of the scroll portion of the casing 133 inside of the longitudinal end portions 150a and 150b of the one side surface 150. Alternatively, the electronic member may be located in a space on one side of the air suction port 136 or 137 of the casing 133 inside the longitudinal end portions 150a and 150b of the one side surface 150. The electronic member may be located at a position of the space of a rectangular parallelepiped shape defined by the height dimension H of the cell stack 101 in the top-bottom direction Z, the length dimension L2 of the cell stack 101 in the stack direction X, and the dimension L3 of the blower members 130 in the longitudinal direction Y (i.e., air flow direction) of the cell modules 105, as shown in FIG. 15. That is, the electronic member is located by effectively using the dead space other than the mounting space of the blower members 130, among the rectangular parallelepiped space defined by the dimensions H, L2 and L3. Accordingly, the electronic member can be mounted without increasing the entire dimension of the cell heating device, thereby improving the mounting performance of the cell heating device to a vehicle.

The blower member 130 is provided with the air passage 135 having the expanding width portion expanding as toward the air outlet of the blower member 130. Thus, the cool air blown by the blower member 130 can be uniformly distributed to the cell stack 101, while the dimension of the blower member 130 can be reduced.

Because the blower member 130 is provided with the centrifugal fan such as sirocco fan 134 while having the expanding air passage 135, the cooling air of high-static pressure can be sent to the cell stack 101. Furthermore, even when air is blown by the blower member 130 to a narrow air passage, air blowing noise can be reduced while the consumption energy of the blower member 130 is reduced.

Because the air outlet of the blower member 130 is a flat opening, the flow speed of air blown from the air outlet of the blower member 130 can be increased even when the flow amount of air blown from the air outlet of the blower member 130 is small. Thus, the cooling capacity for cooling the cell modules 105 can be improved without increasing the noise in the blower member 130.

An electronic member, which can be operated inefficiently for the heating of the cell modules 105, may be located in the side space on one side of the casing 133 of the blower member 130 inside of the longitudinal end portions 150a and 150b of the one side surface 150 of the cell stack 101.

Thus, the electronic member can be mounted by effectively using the space defined by the dimension L2 in the longitudinal direction (stack direction X) of the cell stack 101 and the dimension H of the casing 133 in the top-bottom direction. Accordingly, heat radiated from the electronic member in the inefficient control operation can be easily effectively supplied to the cell stack 101 via the air blown by blower member 130.

The electronic member, which can be operated inefficiently for the heating of the cell modules 105 in the inefficient control operation, may be the vehicle ECU 103 or the battery monitoring device 108. In this case, the vehicle ECU 103 or the battery monitoring device 108 can be mounted by effectively using the space defined by the dimension L2 in the longitudinal direction (stack direction X) of the cell stack 101 and the dimension H of the casing 133 in the top-bottom direction. The shape of the vehicle ECU 103 or the battery monitoring unit 108 may be mounted in the dead space within the box of the cell stack 101. In this case, the size of the cell heating device can be effectively reduced.

### Other Embodiments

Although the present invention has been fully described in connection with the preferred embodiments thereof with reference to the accompanying drawings, it is to be noted that various changes and modifications will become apparent to those skilled in the art.

In the above described embodiments, the cell stack 101, which can be heated via a fluid such as water or air, may be suitably used as a battery for supplying electrical power to a motor for traveling a hybrid vehicle or an electrical vehicle, or may be suitably used for a fuel cell of a fuel cell vehicle.

In the above described embodiments, the arrangement position of any device that requests a heating is not limited to be arranged in the coolant circuit of the examples, but may be arranged in any fluid circuit (not shown). That is, the device that receivers heat from an electronic member in the inefficient control operation (heat increasing operation) may be arranged at any position capable of receiving the heat generated from the electronic member in the thermal management system.

For example. in the thermal management system having the second coolant circuit 20, the coolant of the second coolant circuit 20 can be circulated to the engine 11 while being radiated in the radiator 24. In this case, the engine 11 can be effectively cooled by effectively using the coolant of the second coolant circuit 20. Accordingly, in the general operation of the engine 11, the cooling of the engine 11 can be facilitated.

In the above-described thermal management system of any one of the first to seventh embodiments, the coolant is water and a water-cooled cell is used. However, an air-cooled cell may be used in the thermal management system of any one of the first to seventh embodiments. For example, in the thermal management system, coolant of the second coolant circuit 20 may be supplied to the heater core 13 after being radiated in the radiator 24, and air is blown by the blower member 130 to the cell stack 101. In this case, the temperature of the cell stack 101 can be adjusted by effectively using the coolant of the second coolant circuit 20 with the operation of the radiator 24.

In the above example of FIG. 15 of the eighth embodiment, the fan rotation axis 132 is positioned substantially in the horizontal direction. However, the fan rotation axis 132 may extend in a vertical direction or the other direction in accordance the mounting state in a vehicle.

In the above-described eighth embodiment, the plural cell modules 105 may be arranged with a predetermined clearance between adjacent two in the stack direction X that is perpendicular to the air blowing direction Y. In this case, the air blown by the blower member 130 flows through the plural predetermined clearances extending in the air blowing direction Y, and is discharged from the air discharge port of the cell stack 101. Accordingly, heat from the cell modules 105 can be effectively absorbed by using air passing through the clearances between the cell modules 105 in the cell stack 101.

Such changes and modifications are to be understood as being within the scope of the present invention as defined by the appended claims.

What is claimed is:

1. A thermal management system for a vehicle, comprising:
a switching power supply device;
an electronic member, which is configured to output an electrical power adjusted by the switching power supply device; and
a control device configured to control operation of the switching power supply device so as to control operation of the electronic member, wherein
when the control device receives a heating request from at least one of devices that include a drive device used for driving the vehicle and an air conditioning device used for performing an air conditioning in a vehicle compartment, the control device causes the switching power supply device to be operated in a heat increasing operation in which heat generated from the electronic member is increased more than that in a general operation state, and supplies the generated heat to the at least one of the drive device and the air conditioning device.

2. The thermal management system according to claim 1, wherein the control device increases the number of transient states in which electrical current and electrical voltage applied to the switching power supply device vary or the time for each transient state during the heat increasing operation, to be larger than that in the general operation state.

3. The thermal management system according to claim 1, wherein the control device inputs a control signal in which at least one of a drive frequency and a duty ratio is increased as compared with the general operation state, to the switching power supply device, during the heat increasing operation.

4. The thermal management system according to claim 1, wherein the control device increases at east one of electrical current and electrical voltage applied to the switching power supply device as compared with the general operation state, during the heat increasing operation.

5. The thermal management system according to claim 1, wherein the electronic member is at least one of an inverter, a voltage increasing converter, a DC/DC converter.

6. The thermal management system according to claim 1, wherein
when the control device receives a heating request from a cell stack that is a device having the heating request and is configured to supply electrical power to a motor for a vehicle traveling, the control device causes the switching power supply device to be operated in the heat increasing operation, and supplies the generated heat to the cell stack.

7. The thermal management system according to claim 1, wherein
when the control device receives a heating request from an engine for a vehicle traveling, which is a device having the heating request, the control device causes the switching power supply device to be operated in the heat increasing operation, and supplies the generated heat to the engine.

8. The thermal management system according to claim 1, wherein
when the control device receives a heating request from a motor for a vehicle traveling, which is a device having the heating request, the control device causes the switching power supply device to be operated in the heat increasing operation, and supplies the generated heat to the motor.

9. The thermal management system according to claim 1, wherein
when the control device receives a heating request from a component of a refrigerant cycle used for the air conditioning of the vehicle compartment, the control device causes the switching power supply device to be operated in the heat increasing operation, and supplies the generated heat to the component of the refrigerant cycle.

10. The thermal management system according to claim 1, wherein
when the control device receives a heating request for a heater core for heating air to be blown into the vehicle compartment, the control device causes the switching power supply device to be operated in the heat increasing operation, and supplies the generated heat to the heater core.

11. The thermal management system according to claim 1, further comprising
a fluid circuit in which a fluid circulates, wherein
both the device having the heating request and the electronic member are located in the fluid circuit to perform heat exchange with the fluid, and
the fluid circuit is configured to supply the heat generated in the heat increasing operation to the device having the heating request via the fluid as a thermal medium.

12. The thermal management system according to claim 1, further comprising:
a first fluid circuit in which a fluid circulates; and
a second fluid circuit in which the fluid circulates, the second fluid circuit being connected to the first fluid circuit to be separated from the first fluid circuit, wherein
the device having the heating request is located in the first fluid circuit to perform heat exchange with the fluid in the first fluid circuit,
the electronic member is located in the second fluid circuit to perform heat exchange with the fluid in the second fluid circuit, and
the control device controls the first and second fluid circuits to be connected in the heat increasing operation, so as to supply the heat generated in the heat increasing operation, to the device having the heating request via the fluid as a thermal medium.

13. The thermal management system according to claim 1, wherein
when the control device receives a heating request from a cell stack of the vehicle, which is a device having the heating request, the control device connects a fluid passage through which a heater core for heating air to be blown into the vehicle compartment is connected to the electronic member, and supplies the heat generated in the heat increasing operation to the cell stack by using air heated by the heater core as a thermal transmission medium.

14. A thermal management system comprising:
a cell stack in which a plurality of cell modules are electrically connected and are stacked to be integrated;
a switching power supply device;
an electronic member, which is configured to output an electrical power adjusted by the switching power supply device, and is adapted to charge and discharge the cell modules or to adjust a temperature of the cell modules; and
a control device configured to control operation of the switching power supply device, and perform a heating of the cell stack when a predetermined condition is satisfied, wherein
when the control device detects that a temperature of the cell modules is lower than a predetermined temperature, the control device causes the switching power supply device to be operated in an inefficient control operation in which the number of transient states where electrical current and electrical voltage applied to the switching power supply device vary or the time for each transient state is larger than that in a general operation state.

15. The thermal management system according to claim 14, wherein
the switching power supply device is a power element, and
the control device increases at least one of a drive frequency and a duty ratio inputted to the power element, so as to perform the inefficient control operation.

16. The thermal management system according to claim 15, wherein
the control device changes an increase amount of at least one of the drive frequency and the duty ratio inputted to the power element, based on the temperature of the cell modules when the temperature of the cell modules is lower than the predetermined temperature.

17. The thermal management system according to claim 14, wherein
the control device determines that the temperature of the cell modules is lower than the predetermined temperature, by using at least one of (a) cell information that includes a temperature, a voltage, a current and an inner resistance of the cell modules, (b) environmental information of the cell modules including an environmental temperature, and (c) system information that includes a temperature or an operation state of the switching power supply device or the electronic device.

18. The thermal management system according to claim 14, wherein
the electronic member includes a DC/DC converter connected between a high-voltage electrical power system including the cell stack and a low-voltage electrical power system including a low-voltage battery, and
the high-voltage electrical power system is connected to a high-voltage load to be able of supplying and receiving electrical power, and the low-voltage battery is connected to a low-voltage load to supply electrical power to the low-voltage load.

19. The thermal management system according to claim 14, wherein the cell stack is approximately a rectangular parallelepiped shape, the thermal management system further comprising
a blower member located adjacent to one surface of the cell stack, the blower member including a centrifugal fan accommodated in a casing, wherein
the casing is provided with a suction port opened in a direction parallel to a longitudinal direction of the one surface of the cell stack, and an air passage expanding as toward an air outlet that is opened toward the cell stack, and
the electronic member is located at a side of the casing, inside longitudinal ends of the one surface of the cell stack.
